(19) United States
(12) Patent Application Publication
(10) Pub. No.: US 2020/0210866 A1
(43) Pub. Date: Jul. 2, 2020

(54) INFORMATION PROCESSING DEVICE, INFERENCE PROCESSING DEVICE, AND INFORMATION PROCESSING SYSTEM

(71) Applicant: FUJITSU CLIENT COMPUTING LIMITED, Kanagawa (JP)

(72) Inventors: Yuichiro Ikeda, Kawasaki (JP); Kai Mihara, Kawasaki (JP)

(73) Assignee: FUJITSU CLIENT COMPUTING LIMITED, Kanagawa (JP)

(21) Appl. No.: 16/690,526

(22) Filed: Nov. 21, 2019

(30) Foreign Application Priority Data
Dec. 28, 2018 (JP) 2018-248665
Dec. 28, 2018 (JP) 2018-248666

(51) Int. Cl. G06N 5/04; G06N 20/00

(52) U.S. Cl. CPC G06N 5/04; G06N 20/00

(57) ABSTRACT

An information processing device includes: a main processor. The main processor receives resource information related to a processing status from each of N processors assuming that N is an integral number equal to or larger than 2, applies the received resource information of the N processors to a computational expression, and calculates processing times corresponding to a processing request from an application for the respective N processors, selects one processor from among the N processors based on the processing times of the N processors, and transmits the processing request to the one processor.

### CROSS-REFERENCE TO RELATED APPLICATIONS

This application is a based upon and claims the benefit of priority from Japanese Patent Application No. 2018-248665 filed on Dec. 28, 2018, and Japanese Patent Application No. 2018-248666 filed on Dec. 28, 2018, the entire contents of all of which are incorporated herein by reference.

### FIELD

Embodiments described herein relate generally to an information processing device, an inference processing device, and an information processing system.

### BACKGROUND

In information processing devices to which a plurality of processors are connected in a communicable manner, parallel distributed control is performed to distribute processing among the processors in some cases.

However, when parallel distributed control is regularly performed by the information processing device, processing efficiency of a plurality of processors may be lowered.

In an inference processing device including a pre-learned model that is generated by machine learning in advance, various kinds of inference processing may be performed by using the pre-learned model.

However, when the same pre-learned model is used for various kinds of inference processing in the inference processing device, inference processing is not efficiently performed in some cases.

### SUMMARY

According to one aspect of the present disclosure, an information processing device includes a main processor. The main processor is configured to receive resource information related to a processing status from each of N processors assuming that N is an integral number equal to or larger than 2, apply the received resource information of the N processors to a computational expression, and calculate processing times corresponding to a processing request from an application for the respective N processors, select one processor from among the N processors based on the processing times of the N processors, and transmit the processing request to the one processor.

According to another aspect of the present disclosure, an inference processing device includes a processor. The processor is configured to cause middleware to be able to execute a plurality of mode files corresponding to different pieces of inference processing, and cause an inference application to receive a first inference request including a first inference processing identifier and first input data from outside, and to specify a model file corresponding to the first inference processing identifier among the model files. The processor causes the middleware to read the specified model file and to perform the inference processing.

### BRIEF DESCRIPTION OF THE DRAWINGS

FIG. 1 is a diagram illustrating a hardware configuration of an information processing system according to an embodiment;

FIG. 2 is a diagram illustrating a functional configuration of an information processing device according to the embodiment;

FIG. 3 is a diagram illustrating a functional configuration of an inference processing device according to the embodiment;

FIG. 4 is a diagram illustrating a data structure of discrimination parameter information according to the embodiment;

FIGS. 5A and 5B are diagrams illustrating update processing for the discrimination parameter information according to the embodiment (in a case of a coprocessor A and processing J);

FIGS. 6A and 6B are diagrams illustrating update processing for the discrimination parameter information according to the embodiment (in a case of the coprocessor A and processing K);

FIGS. 7A and 7B are diagrams illustrating update processing for the discrimination parameter information according to the embodiment (in a case of a coprocessor B and processing J);

FIG. 8 is a diagram illustrating an operation using a model file of the inference processing device according to the embodiment;

FIGS. 9A and 9B are diagrams illustrating conversion processing from a common format into a format of an input layer of the model file according to the embodiment;

FIGS. 10A to 10C are diagrams illustrating conversion processing from a format of an output layer of the model file into the common format according to the embodiment;

FIG. 11 is a diagram illustrating an operation using another model file of the inference processing device according to the embodiment;

FIGS. 12A and 12B are diagrams illustrating conversion processing from the common format into a format of an input layer of another model file according to the embodiment;

FIGS. 13A to 13C are diagrams illustrating conversion processing from a format of an output layer of another model file into the common format according to the embodiment;

FIG. 14 is a diagram illustrating a functional configuration of an inference processing device according to a modification of the embodiment;

FIG. 15 is a diagram illustrating a hardware configuration of an information processing system according to another modification of the embodiment;

FIG. 16 is a diagram illustrating a software configuration of the information processing system according to another modification of the embodiment;

FIG. 17 is a diagram illustrating a hardware configuration of a PCIe bridge controller according to another modification of the embodiment;

FIG. 18 is a diagram illustrating a layer configuration of a PCIe according to another modification of the embodiment;

FIG. 19 is a diagram illustrating appearance of other processors viewed from a coprocessor G according to another modification of the embodiment;

FIG. 20 is a diagram illustrating appearance of other processors viewed from a coprocessor D according to another modification of the embodiment; and

FIG. 21 is a diagram illustrating data transfer processing between processors via the PCIe bridge controller according to another modification of the embodiment.

### DETAILED DESCRIPTION

Embodiments of an information processing device disclosed by the subject application will be described in detail below with reference to the drawings. It should be noted that the disclosed technique is not limited by the embodiments. The configuration having the same function in embodiments is denoted by the same reference sign and an overlapping description will be omitted.

### Embodiment

An information processing system according to an embodiment is a parallel distribution system including a main processor and a plurality of coprocessors in which the main processor performs parallel distributed control of distributing processing among the coprocessors. In the information processing system, when parallel distributed control is regularly performed by the main processor, processing efficiency of the coprocessors may be lowered in some cases.

For example, assumed is control of assigning processing having a large load to a coprocessor having a high arithmetic processing capacity, and assigning processing having a small load to a coprocessor having a low arithmetic processing capacity considering a difference in the arithmetic processing capacity among a plurality of coprocessors. In this control, in a case in which the parallel distribution system includes a coprocessor that performs specific processing at high speed, appropriate (for example, optimum) parallel distributed control cannot be performed depending on a vacancy status of current resource of the coprocessors in some cases.

In a case in which each coprocessor (each inference processing device) includes a pre-learned model that is generated by machine learning in advance, various kinds of inference processing may be performed using the pre-learned model by each inference processing device. In this case, when the same pre-learned model is used for various kinds of inference processing by the inference processing device, inference processing is not efficiently performed in some cases.

Thus, the present embodiment aims to cause parallel distributed control to be efficient in real time by applying resource information collected from a plurality of coprocessors to computational expressions corresponding to the number of coprocessors to calculate processing times by the information processing system, and selecting a coprocessor to which inference processing is assigned and transmitting an inference request based on obtained processing times of the coprocessors.

The present embodiment also aims to cause inference processing to be efficient in each coprocessor (each inference processing device) by causing an inference processing identifier for identifying inference processing to be included in the inference request, and causing each coprocessor (each inference processing device) to specify and read a model file corresponding to the inference processing identifier included in a received inference request among a plurality of model files, and perform inference processing.

Specifically, in the information processing system, a plurality of computational expressions associated with combinations of processing content and a coprocessor are prepared. Each computational expression includes a plurality of parameters (a plurality of discrimination parameters) corresponding to a plurality of coprocessors, and is configured so that a processing time can be obtained by applying (substituting) resource information of the coprocessors thereto. The information processing system calculates the processing time by applying the resource information collected from the coprocessors to the respective computational expressions corresponding to the number of coprocessors corresponding to the inference request from an application among the prepared computational expressions. The information processing system selects a coprocessor to which processing is assigned and transmits the inference request based on the processing times of the coprocessors obtained by calculation. For example, the information processing system can transmit the inference request by selecting a coprocessor having the shortest processing time. Due to this, processing content can be considered in addition to the arithmetic processing capacity as a difference in performance, so that accuracy of parallel distributed control can be increased and a vacancy status of the current resource can be considered. Accordingly, parallel distributed control can be caused to be efficient in real time.

The information processing system transmits the inference request including the inference processing identifier and input data to the selected coprocessor (each inference processing device). Each of the coprocessors (inference processing devices) includes a plurality of model files respectively corresponding to different pieces of inference processing. Each of the model files corresponds to a pre-learned inference model on which machine learning is performed to be adapted to the different pieces of inference processing. The coprocessor (inference processing device) that has received the inference request specifies a model file corresponding to the inference processing identifier included in the inference request, reads the specified model file, and performs inference processing. Due to this, it is possible to use the model file that is caused to be efficient by machine learning for each piece of inference processing as compared with a case in which the same pre-learned model is used for various kinds of inference processing, so that inference processing performed by each coprocessor (each inference processing device) can be caused to be efficient.

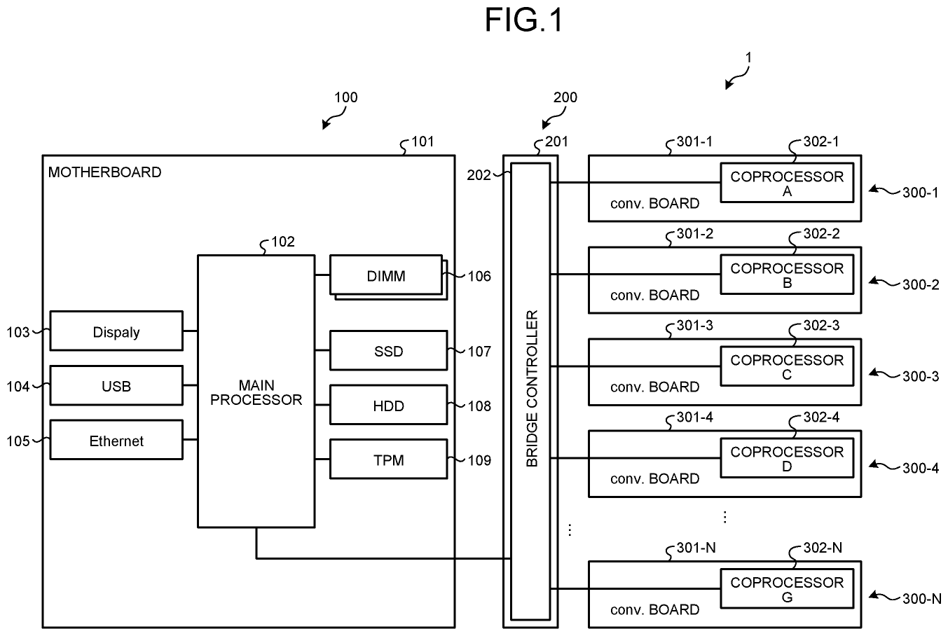

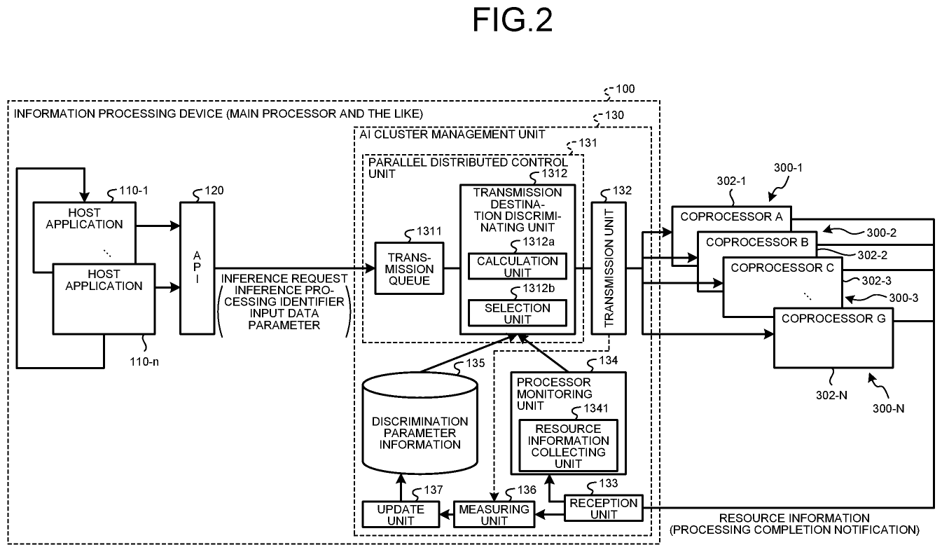

Specifically, an information processing system 1 may be configured as illustrated in FIGS. 1 and 2. FIG. 1 is a diagram illustrating a hardware configuration of the information processing system 1. FIG. 2 is a diagram illustrating a functional configuration of an information processing device 100.

Assuming that N is an optional integral number equal to or larger than 2, the information processing system 1 includes the information processing device 100, a relay device 200, and N inference processing devices 300-1 to 300-N.

As illustrated in FIG. 1, the information processing device 100 includes a motherboard 101, a main processor 102, a display 103, a universal serial bus (USB) interface 104, an Ethernet (registered trademark) interface 105, a dual inline memory module (DIMM) 106, a solid state drive (SSD) 107, a hard disk drive (HDD) 108, and a trusted platform module (TPM) 109 as a hardware configuration.

The motherboard 101 illustrated in FIG. 1 is a substrate on which components having main functions of the information processing device 100 are mounted. The main processor 102 is a processor having a main function of the information processing device 100, and an electronic unit such as a central processing unit (CPU) and a micro processing unit (MPU) can be employed as the main processor 102. The display 103 functions as a display unit that displays various kinds of information. The USB interface 104 can be connected to a USB device, and can mediate communication between the USB device and the main processor 102. The Ethernet interface 105 can be connected to an Ethernet cable, and can mediate communication between an external apparatus and the main processor 102 via the Ethernet cable. The DIMM 106 is a volatile storage medium such as a random access memory (RAM) that can temporarily store various kinds of information. The SSD 107 and the HDD 108 are non-volatile storage mediums that can store various kinds of information even after power is interrupted. The TPM 109 is a module that implements a security function of the system.

The information processing device 100 also includes, as functional configurations, host applications 110-1 to 110-n (n is an optional integral number equal to or larger than 2), an application programming interface (API) 120, and an AI cluster management unit 130 as illustrated in FIG. 2. Each of the functional configurations illustrated in FIG. 2 may be functionally configured in the main processor 102.

The relay device 200 illustrated in FIG. 1 includes a bridge board 201 and a bridge controller 202. The bridge board 201 is a substrate on which the bridge controller 202 is mounted. The bridge controller 202 bridge-connects a plurality of inference processing devices 300 to the information processing device 100, and mediates (relays) communication between the information processing device 100 and the inference processing devices 300.

The inference processing devices 300-1 to 300-N are connected to the relay device 200 in parallel with each other. Each of the inference processing devices 300-1 to 300-N includes conversion boards (conv. board) 301-1 to 301-N and coprocessors 302-1 to 302-N. The conversion board 301 is also called an accelerator board, which is a substrate on which hardware to be additionally used is mounted for improving a processing capacity of the information processing system 1.

The coprocessor 302 is a processor suitable for parallel arithmetic processing such as artificial intelligence (AI) inference processing and image processing, and an accelerator and the like such as a graphics processing unit (GPU) and a dedicated chip can be employed as the coprocessor 302. The coprocessor 302 may also be a combination of a CPU and a GPU.

The AI inference processing is inference processing using artificial intelligence (AI), and includes inference processing with an inference model using a neural network having a multilayer structure (hierarchical neural network). Each processor 302 can generate a pre-learned inference model by performing machine learning on the inference model using the hierarchical neural network, and can utilize the pre-learned inference model.

Regarding the model file 304 as a pre-learned inference model, when the same pre-learned model is used for various kinds of inference processing, inference processing is not performed efficiently in some cases.

For example, in the inference processing by machine learning, a system obtained by combining a plurality of pieces of inference processing may be required so as to extract a plurality of pieces of data of interest from a large amount of data, and further investigate the pieces of data of interest. By way of example, this is implemented by any of two methods A and B as follows.

A A plurality of pieces of processing are performed by a high-performance inference processing device.

B Each of a plurality of inference processing device performs fixed inference processing.

For example, in a case of a system of detecting a person from a camera image and counting the number of men and women respectively, the following pieces of processing (1) and (2) are performed.

(1) Person extraction inference processing is performed on a camera image.

(2) As a result of (1), the following pieces of inference processing (α) and (β) are performed for each extracted person.

(α) Man/woman determination inference processing is performed.

(β) In accordance with a determination result of (α), the numbers of men and woman are counted up.

By applying these pieces of processing to patterns of A and B described above, the following (a′) and (b′) is obtained.

(a′) A high-performance inference processing device expands all pieces of the person extraction inference processing and the man/woman determination inference processing into an executable state to perform the processing of (1) and (2).

(b′) In a case of performing the processing by a plurality of inference processing devices, the person extraction inference processing is performed by one inference processing device, and the man/woman determination inference processing for a plurality of extracted persons is performed by a plurality of inference processing devices.

In both of the case of performing the processing by a high-performance inference processing device and the case of performing the processing by a plurality of inference processing devices, inference processing to be performed is fixed, and performance of the inference processing device cannot be efficiently utilized in some cases.

From this viewpoint, content of the inference processing is classified and typified in some degree, and a plurality of model files 304 respectively corresponding to different pieces of inference processing are prepared in the respective inference processing devices 300-1 to 300-N so that a piece of inference processing to be performed can be designated with an inference request identifier.

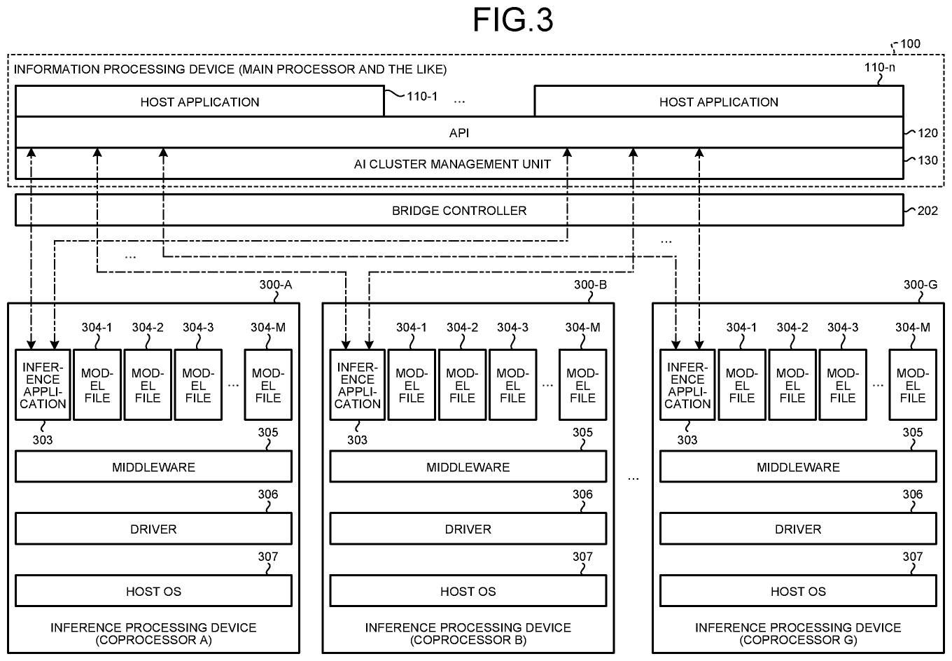

That is, assuming that M is an optional integral number equal to or larger than 2, as illustrated in FIG. 3, each of the inference processing devices 300-1 to 300-N includes a host operating system (OS) 307, a driver 306, middleware 305, M model files 304-1 to 304-M, and an inference application 303. FIG. 3 is a diagram illustrating a functional configuration of the inference processing device 300.

The M model files 304-1 to 304-M respectively correspond to different pieces of inference processing. The middleware 305 can execute each of the M model files 304-1 to 304-M. The inference application 303 receives an inference request including the inference processing identifier, the input data, and the parameter from the outside, and specifies a model file corresponding to the inference processing identifier among the M model files 304-1 to 304-M. The middleware 305 reads the model file 304 specified by the inference application 303, and performs inference processing.

For example, in an initial state, the model files 304-1 to 304-M including the inference model using the hierarchical neural network and the middleware 305 that should read the model file and perform inference processing are stored in the SSD 107 and/or the HDD 108 in the information processing device 100 illustrated in FIG. 1.

The hierarchical neural network has a hierarchical structure, and may include a plurality of intermediate layers between an input layer and an output layer. The intermediate layers include, for example, a convolution layer, an activation function layer, a pooling layer, a fully connected layer, and a softmax layer. The convolution layer performs a convolution arithmetic operation (convolution processing) on neuron data input from the input layer, and extracts a characteristic of the input neuron data. The activation function layer emphasizes the characteristic extracted by the convolution layer. The pooling layer thins out the input neuron data. The fully connected layer couples extracted characteristics to generate a variable representing the characteristics. The softmax layer converts the variable generated by the fully connected layer into a probability. The neuron data as an arithmetic result obtained by the softmax layer is output to the output layer, and subjected to predetermined processing (for example, identification of an image) in the output layer. The numbers and positions of the layers may be changed as needed depending on required architecture. That is, the hierarchical structure of the neural network and the configuration of each layer can be determined in advance by a designer in accordance with an object to be identified and the like.

That is, each of the model files 304-1 to 304-M as an inference model includes definition information and weight information for the inference model (hierarchical neural network). The definition information is data that stores information related to the neural network. For example, the definition information stores information indicating the configuration of the neural network such as a hierarchical structure of the neural network, a configuration of a unit of each hierarchical level, and a connection relation among units. In a case of recognizing an image, the definition information stores information indicating a configuration of a convolution neural network determined by a designer and the like, for example. The weight information is data that stores a value of weight such as a weight value used in an arithmetic operation for each layer of the neural network. The weight value stored in the weight information is a predetermined initial value in the initial state, and updated in accordance with learning.

At the time of starting the information processing system 1, for example, the model files 304-1 to 304-M and the middleware 305 are read out from the SSD 107 and/or the HDD 108 by the main processor 102, and loaded into the predetermined inference processing device 300 (predetermined coprocessor 302) via the bridge controller 202. The predetermined inference processing device 300 (predetermined coprocessor 302) performs machine learning on each of the model files 304-1 to 304-M with the middleware 305. The middleware 305 performs machine learning on the respective model files 304-1 to 304-M corresponding to different pieces of inference processing, the machine learning suitable for a piece of inference processing corresponding thereto.

This machine learning can be machine learning using a neural network having a multilayer structure, and is also called deep learning. In deep learning, multilayering of the neural network has been developed, and the validity thereof is confirmed in many fields. For example, deep learning exhibits high recognition accuracy in recognizing an image/voice as a match for a person.

In deep learning, by performing supervised learning related to an object to be identified, a characteristic of the object to be identified is automatically learned by the neural network. In deep learning, the object to be identified is identified by using the neural network that has learned the characteristic. The predetermined inference processing device 300 (predetermined coprocessor 302) may cause the model files 304-1 to 304-M to learn characteristics of different objects to be identified so that models become suitable for different pieces of inference processing.

For example, as an example of person detection in an image as the inference processing, in deep learning, a characteristic of the entire person reflected in an image is automatically learned by the neural network by performing supervised learning on a large number of images in which the entire person is reflected as images for learning. Alternatively, as an example of face detection in an image as the inference processing, in deep learning, a characteristic of a face of a person reflected in an image is automatically learned by the neural network by performing supervised learning on a large number of images in which a face of a person is reflected as images for learning.

In an error back-propagation method that is typically used in supervised learning, data for learning is forward-propagated to the neural network to perform recognition, and a recognition result is compared with a correct answer to obtain an error. In the error back-propagation method, the error between the recognition result and the correct answer is propagated to the neural network in a direction reverse to the direction at the time of recognition, and a weight of each hierarchical level of the neural network is changed to be closer to an optimal solution.

There are a large number of neurons (nerve cells) in a brain. Each of the neurons receives a signal from the other neuron, and passes the signal to the other neuron. The brain performs various kinds of information processing in accordance with a flow of the signal. The neural network is a model obtained by implementing a characteristic of such a function of a brain on a calculator. The neural network couples units imitating neurons of a brain in a hierarchical manner. The unit is also called a node. Each of the units receives data from the other unit, and applies a weight to the data to be passed to the other unit. The neural network can identify (recognize) various objects to be identified by varying the weight of the unit through learning to vary the data to be passed.

In deep learning, by using the neural network that has learned the characteristic as described above, it is possible to generate a pre-learned inference model that can perform inference processing such as identifying an object to be identified reflected in an image.

When the pre-learned inference model is generated, the predetermined coprocessor 302 causes the SSD 107 and/or the HDD 108 to store the model file 304 as the pre-learned inference model and the middleware 305 used for machine learning via the bridge controller 202 and the main processor 102.

For example, at the timing when the pre-learned inference model should be utilized or before the timing, the model file 304 and the middleware 305 are read out from the SSD 107 and/or HDD 108 by the main processor 102, and may be loaded into each of the coprocessors 302-1 to 302-N via the bridge controller 202. Each coprocessor 302 can perform predetermined AI inference processing by using the model file 304 as the pre-learned inference model with the middleware 305 (refer to FIG. 3).

The same processing may be repeatedly performed in AI inference processing. For example, in inference processing for person detection, a person in an image may be repeatedly detected. In a case in which the coprocessor 302 performs processing of repeatedly performing the same processing such as AI inference processing, an approximate processing time can be estimated from resource statuses of the coprocessors 302-1 to 302-N, and when the approximate processing time is utilized for parallel distributed control, the information processing device 100 can perform distributed control more efficiently. That is, in a case in which processing performance is different among the coprocessors 302-1 to 302-N, based on information about the resource status of a processor of the coprocessors 302-1 to 302-N for each piece of processing content, a processing time for the piece of processing content can be calculated for each of the coprocessors 302-1 to 302-N. By selecting the coprocessor 302 appropriate for the processing content (task) (for example, a coprocessor that returns a response fastest) based on calculated processing times of the coprocessors 302-1 to 302-N, efficiency in assignment of tasks can be improved, and processing performance of the entire system can be improved accordingly.

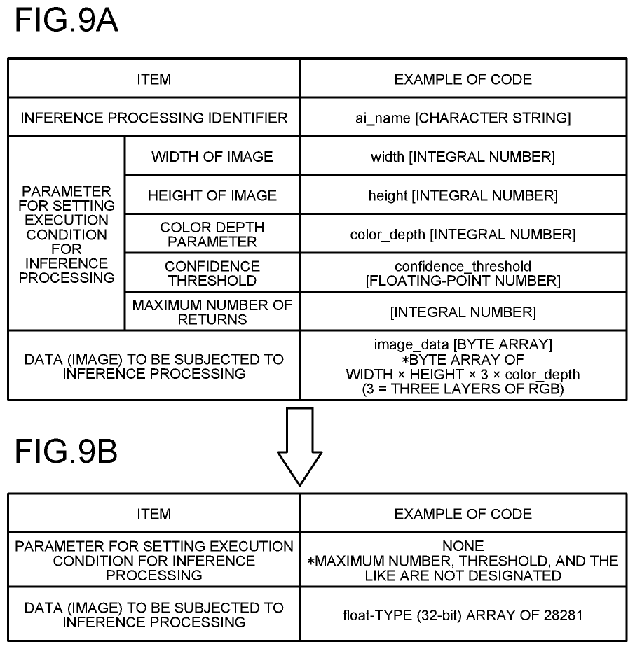

For example, the API 120 illustrated in FIG. 2 functions as an interface for interprocess communication between the host applications 110-1 to 110-n and the AI cluster management unit 130, and prescribes an object exchange format as a common format, for example. That is, the API 120 absorbs a difference in format among the host applications 110-1 to 110-n, and enables transmission/reception of information to/from the AI cluster management unit 130 in the common format. In response to an inference instruction from the host application 110, the API 120 can generate an inference request in the common format as an inference request including an inference processing identifier, input data, and a parameter (refer to FIG. 9A).

The inference instruction from the application to the API 120 may be implemented as a function ‘estimate (AIName, InData, Param, Func)’, for example.

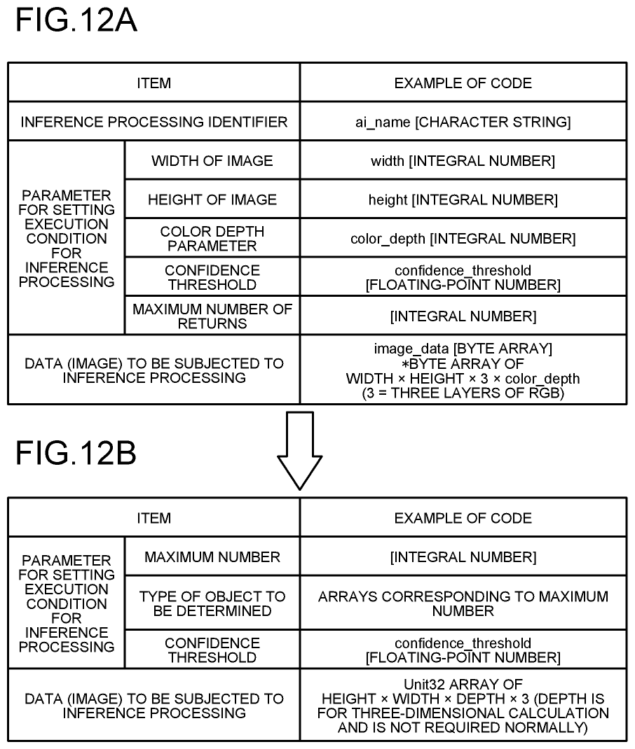

“AIName” designated as an argument of the function ‘estimate’ corresponds to the inference processing identifier in the inference request, and may designate information for identifying AI inference processing (model file) to be executed as data of a character string (string) type. For example, “AIName” (refer to FIGS. 9A and 12A) may be information (for example, a name of the model file) for identifying the model files 304-1 to 304-k (refer to FIG. 3).

“InData” designated as an argument of the function ‘estimate’ corresponds to the input data in the inference request, and may designate the input data to be processed in the AI inference processing as data of a multidimensional array (numpy) type. “InData” is, for example, image data, and may be a multidimensional array that returns, when receiving a pixel position (lateral position, longitudinal position) as an argument, a gradation value (color depth) thereof as an element (refer to FIGS. 9A and 12A).

“Param” designated as an argument of the function ‘estimate’ corresponds to the parameter in the inference request, and may designate a condition and the like for performing narrowing in the AI inference processing as data of a character string (string) type (refer to FIGS. 9A and 12A).

The function ‘estimate’ may return an acceptance number as data of an integral number (int) type as a return value.

The host applications 110-1 to 110-n generate a predetermined inference instruction to execute the API 120 in response to an instruction from a user, a request from the system, or the like. The API 120 generates the inference request including the inference processing identifier, the input data, and the parameter in the common format (refer to FIG. 9A) in response to a request instruction instructed as the function ‘estimate (AIName, InData, Param, Func)’, for example, and transmits the inference request to the AI cluster management unit 130. That is, every time the API 120 is executed by the host application 110, the inference request corresponding to the inference instruction from the application is transmitted to the AI cluster management unit 130 in the common format as the inference request from the host application 110. Thereafter, the API 120 returns the acceptance number to the host application 110 as a return value of the function ‘estimate (AIName, InData, Param, Func)’, for example.

The AI cluster management unit 130 illustrated in FIG. 2 manages the AI inference processing performed by the inference processing devices 300-1 to 300-N. The AI cluster management unit 130 monitors which AI inference processing (which model file) is performed by which inference processing device 300 (which coprocessor 302), and controls which AI inference processing (which model file) should be performed by which inference processing device 300 (which coprocessor 302). The AI cluster management unit 130 may perform parallel distributed control of assigning the pieces of AI inference processing to the coprocessors 302-1 to 302-N.

That is, when receiving the inference request from the host application 110, the AI cluster management unit 130 applies resource information collected from the coprocessors 302-1 to 302-N to computational expressions corresponding to the number of the coprocessors 302 (in a case of FIG. 2, seven) to calculate processing times in response to the inference request. The AI cluster management unit 130 selects the coprocessor 302 to which the AI inference processing is assigned, the AI inference processing indicated by the inference processing identifier included in the inference request, based on the processing times of the coprocessors 302-1 to 302-N obtained through the calculation. The AI cluster management unit 130 may select, as the coprocessor that should perform AI inference processing, the coprocessor 302 having the shortest processing time obtained through the calculation from among the coprocessors 302-1 to 302-N.

The AI cluster management unit 130 includes a parallel distributed control unit 131, a transmission unit 132, a reception unit 133, a processor monitoring unit 134, discrimination parameter information 135, a measuring unit 136, and an update unit 137. The processor monitoring unit 134 includes a resource information collecting unit 1341.

The parallel distributed control unit 131 may receive an inference request of an application from the API 120, and perform parallel distributed control of assigning the pieces of AI inference processing to the coprocessors 302-1 to 302-N in response to the inference request. The parallel distributed control unit 131 includes a transmission queue 1311 and a transmission destination discriminating unit 1312.

The transmission queue 1311 queues the inference request supplied from the API 120. The transmission queue 1311 is a queue buffer having a First In First Out (FIFO) structure, and each inference request is dequeued therefrom in order of queuing.

The transmission destination discriminating unit 1312 includes a calculation unit 1312a and a selection unit 1312b. When receiving a dequeued inference request (inference request in the common format) from the transmission queue 1311, the calculation unit 1312a refers to the discrimination parameter information 135, and specifies a computational expression corresponding to the inference processing identifier included in the dequeued inference request.

The discrimination parameter information 135 includes N×M computational expressions associated with combinations of N different coprocessors and M different pieces of processing content. Each computational expression included in the discrimination parameter information 135 includes N discrimination parameters corresponding to the N coprocessors. Each of the N discrimination parameters may include a conversion coefficient for converting a value of resource information into a processing time and a contribution ratio indicating a degree of influence of the resource information of a corresponding coprocessor on the processing time (predicted value). The ‘conversion coefficient for converting a value of resource information into a processing time’ is a conversion parameter for converting a value of resource information of its own processor (calculation objective processor) into a processing time. The ‘a contribution ratio indicating a degree of influence of the resource information of a corresponding coprocessor on the processing time (predicted value)’ is a contribution parameter indicating a degree of influence to processing time of its own processor from values of the resource information of other processors. The calculation unit 1312a may specify N computational expressions corresponding to the inference processing identifier among the N×M computational expressions.

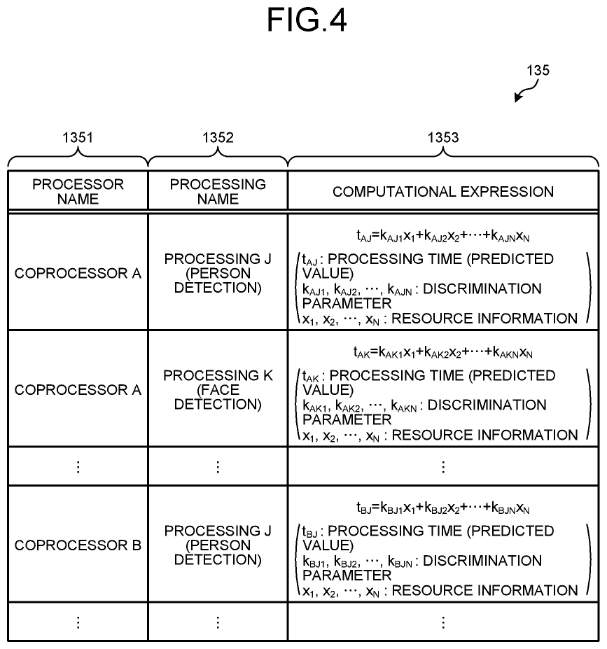

For example, the discrimination parameter information 135 has a data structure as illustrated in FIG. 4. FIG. 4 is a diagram illustrating a data structure of the discrimination parameter information 135. The discrimination parameter information 135 includes a processor identification information column 1351, a processing identification information column 1352, and a computational expression column 1353. In the processor identification information column 1351, information for identifying the processor is recorded, for example, a processor name such as a coprocessor A, a coprocessor B, . . . , and a coprocessor G may be recorded therein. The coprocessor A, the coprocessor B, . . . , and the coprocessor G are, for example, names of the coprocessor 302-1, the coprocessor 302-2, . . . , and the coprocessor 302-N. In the processing identification information column 1352, information for identifying the processing content (that is, information corresponding to the inference processing identifier) is recorded, for example, a processing name such as processing J, processing K, . . . may be recorded therein. The processing J, the processing K, . . . are, for example, names of the model files 304-1, 304-2, . . . . The processing J may correspond to inference processing of detecting a person in an image, for example. The processing K may correspond to inference processing of detecting a face region of a person in an image, for example. In the computational expression column 1353, a computational expression used for calculating the processing time is recorded. By referring to the discrimination parameter information 135 illustrated in FIG. 4, the computational expression corresponding to each combination of the coprocessor and the processing content may be specified.

For example, the computational expression corresponding to a combination of the coprocessor A and the processing J (person detection processing) may be specified to be the following numerical expression 1.

t_{AJ}=k_{AJ1}x₁+k_{AJ2}x₂+ . . . +k_{AJN}x_{N} numerical expression 1

In the numerical expression 1, t_{AJ} indicates the processing time (predicted value) that is calculated in a case in which the coprocessor A performs the processing J. k_{AJ1}, k_{AJ2}, . . . , and k_{AJN} are discrimination parameters respectively corresponding to the coprocessor 302-1, the coprocessor 302-2, . . . , and the coprocessor 302-N, and may include the conversion coefficient for converting the value of the resource information into the processing time and the contribution ratio indicating a degree of influence of the resource information of the coprocessor 302-1, the coprocessor 302-2, . . . , and the coprocessor 302-N on the processing time (predicted value). k_{AJ1} is discrimination parameter corresponding to the coprocessor 302-1, and is the conversion coefficient for converting the value of the resource information into the processing time. The coprocessor 302-1 is its own processor (coprocessor A as shown in FIG. 1). k_{AJ2}, . . . , and k_{AJN} are discrimination parameters corresponding the coprocessor 302-2, . . . , and the coprocessor 302-N, respectively, and is the contribution ratio indicating a degree of influence of the resource information of the coprocessor 302-2, . . . , and the coprocessor 302-N (i.e. coprocessor B through coprocessor G as shown in FIG. 1) on the processing time (predicted value). x₁, x₂, . . . , and x_{N} are variables to which values of the resource information of the coprocessor 302-1, the coprocessor 302-2, . . . , and the coprocessor 302-N should be respectively applied (substituted).

Alternatively, for example, a computational expression corresponding to a combination of the coprocessor A and the processing K (face detection processing) may be specified to be the following numerical expression 2.

t_{AK}=k_{AK1}x₁+k_{AK2}x₂+ . . . +k_{AKN}x_{N} numerical expression 2

In the numerical expression 2, t_{AK} indicates the processing time (predicted value) that is calculated in a case in which the coprocessor A performs the processing K. k_{AK1}, k_{AK2}, . . . , and k_{AKN} are discrimination parameters respectively corresponding to the coprocessor 302-1, the coprocessor 302-2, . . . , and the coprocessor 302-N, and may include the conversion coefficient for converting the value of resource information into the processing time and the contribution ratio indicating a degree of influence of the resource information of the coprocessor 302-1, the coprocessor 302-2, . . . , and the coprocessor 302-N on the processing time (predicted value). k_{AK1} is discrimination parameter corresponding to the coprocessor 302-1, and is the conversion coefficient for converting the value of the resource information into the processing time. The coprocessor 302-1 is its own processor (coprocessor A as shown in FIG. 1). k_{AK2}, . . . , and k_{AKN} are discrimination parameters corresponding the coprocessor 302-2, . . . , and the coprocessor 302-N, respectively, and is the contribution ratio indicating a degree of influence of the resource information of the coprocessor 302-2, . . . , and the coprocessor 302-N (i.e. coprocessor B through coprocessor G as shown in FIG. 1) on the processing time (predicted value). x₁, x₂, . . . , and x_{N} are variables to which the values of the resource information of the coprocessor 302-1, the coprocessor 302-2, . . . , and the coprocessor 302-N should be respectively applied (substituted).

Alternatively, for example, a computational expression corresponding to a combination of the coprocessor B (coprocessor 302-2) and the processing J (person detection processing) may be specified to be the following numerical expression 3.

t_{BJ}=k_{BJ1}x₁+k_{BJ2}x₂+ . . . +k_{BJN}x_{N} numerical expression 3

In the numerical expression 3, t_{BJ} indicates the processing time (predicted value) that is calculated in a case in which the coprocessor B performs the processing J. k_{BJ1}, k_{BJ2}, . . . , and k_{BJN} are discrimination parameters respectively corresponding to the coprocessor 302-1, the coprocessor 302-2, . . . , and the coprocessor 302-N, and may include the conversion coefficient for converting the value of the resource information into the processing time and the contribution ratio indicating a degree of influence of the resource information of the coprocessor 302-1, the coprocessor 302-2, . . . , and the coprocessor 302-N on the processing time (predicted value). K_{BJ2} is discrimination parameter corresponding to the coprocessor 302-2, and is the conversion coefficient for converting the value of the resource information into the processing time. The coprocessor 302-2 is its own processor (coprocessor B as shown in FIG. 1). K_{BJ1}, K_{BJ3}, . . . , and k_{BJN} are discrimination parameters corresponding the coprocessor 302-1, the coprocessor 302-3, . . . , and the coprocessor 302-N, respectively, and is the contribution ratio indicating a degree of influence of the resource information of the coprocessor 302-1, the coprocessor 302-3, . . . , and the coprocessor 302-N (i.e. coprocessor A, coprocessor C through coprocessor G as shown in FIG. 1) on the processing time (predicted value). x₁, x₂, . . . , and x_{N} are variables to which the values of the resource information of the coprocessor 302-1, the coprocessor 302-2, . . . , and the coprocessor 302-N should be respectively applied (substituted).

After specifying the computational expression corresponding to the inference processing identifier, the calculation unit 1312a illustrated in FIG. 2 stands by until the resource information of the respective coprocessors 302-1 to 302-N is supplied.

Each of the coprocessors 302-1 to 302-N transmits the resource information thereof to the AI cluster management unit 130 at predetermined cycles (for example, from every few minutes to every few hours) and/or in response to a request received from the processor monitoring unit 134 via the parallel distributed control unit 131 and the transmission unit 132. The resource information includes, for example, a usage ratio [%] of the processor.

When receiving the resource information related to the processing status from the respective coprocessors 302-1 to 302-N, the reception unit 133 supplies the resource information of the respective coprocessors 302-1 to 302-N to the resource information collecting unit 1341. When receiving the resource information of the respective coprocessors 302-1 to 302-N, the resource information collecting unit 1341 supplies the resource information of the respective coprocessors 302-1 to 302-N to the calculation unit 1312a.

Accordingly, the calculation unit 1312a applies the values of resource information of the respective coprocessors 302-1 to 302-N to the computational expressions to calculate the processing time of each of the coprocessors 302-1 to 302-N.

Assuming that the number of coprocessors is N and the number of pieces of processing content is M, the calculation unit 1312a applies (substitutes) the values of resource information of the N processors to the respective N computational expressions, and obtains processing times (predicted values) of the N processors as a calculation result.

The calculation unit 1312a supplies, to the selection unit 1312b, the processing times of the respective coprocessors 302-1 to 302-N obtained through the calculation.

The selection unit 1312b selects one coprocessor 302 from among the coprocessors 302-1 to 302-N as a coprocessor that should perform inference processing indicated by the inference processing identifier based on the processing time of each of the coprocessors 302-1 to 302-N. The selection unit 1312b may select one coprocessor 302 corresponding to the shortest processing time (predicted value) from among the coprocessors 302-1 to 302-N. The selection unit 1312b supplies, to the transmission unit 132, transmission destination information that designates the one selected coprocessor 302 as a transmission destination and an inference request in the common format.

The transmission unit 132 transmits the inference request in the common format (inference request of AI inference processing) to the coprocessor 302 (inference processing device 300) designated by the transmission destination information. Due to this, parallel distributed control of assigning the pieces of AI inference processing to the coprocessors 302-1 to 302-N may be performed efficiently.

In this case, processing performance of the coprocessors 302-1 to 302-N may be varied due to version-up of firmware thereof and/or replacement of hardware, for example. From this viewpoint, the discrimination parameter information 135 may be updated at a predetermined update timing.

For example, in a case in which the discrimination parameter information 135 is updated when the selected coprocessor 302 performs AI inference processing, the measuring unit 136 measures a time from when the inference request is transmitted to the coprocessor 302 until a processing completion notification of the coprocessor 302 is received as a processing time for the values of resource information of the respective coprocessors 302-1 to 302-N collected by the resource information collecting unit 1341, and can accumulate the measured processing times. At a predetermined update timing (for example, an update timing for every few weeks), the update unit 137 acquires a measurement result of the accumulated processing time of the coprocessors from the measuring unit 136, performs multiple regression analysis using the accumulated processing time of each coprocessor, and newly obtains a computational expression of each coprocessor. At this point, the discrimination parameter is updated in the computational expression of each coprocessor. The update unit 137 accesses the discrimination parameter information 135, and replaces the computational expression of each coprocessor with the newly obtained computational expression by overwriting. Due to this, the update unit 137 updates the discrimination parameter information 135.

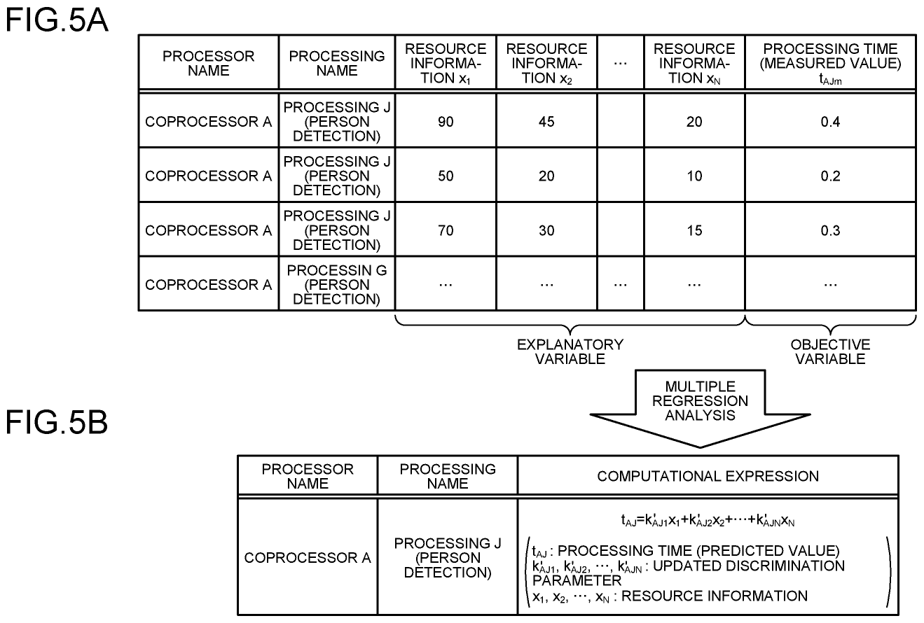

For example, it is assumed that the coprocessor A is selected to perform the processing J (person detection processing) based on the processing time (predicted value) obtained by the numerical expression 1. Through this processing, the measuring unit 136 measures a measurement value t_{AJm}=0.4 [s] of the processing time corresponding to the resource information x₁=90[%], x₂=45[%], x_{N}=20[%] illustrated in the first line of FIG. 5A. Assuming that the computational expression of the numerical expression 1 corresponding to the combination of the coprocessor A and the processing J is an expression obtained by performing multiple regression analysis on past measurement results in the second line and the following lines of FIG. 5A, the computational expression may be changed by adding the newly obtained measurement result in the first line to perform multiple regression analysis. Thus, the measuring unit 136 supplies, to the update unit 137, a measurement result obtained by adding the measurement result in the first line to the past measurement results in the second line and the following lines of FIG. 5A. The update unit 137 performs multiple regression analysis using the measurement value t_{AJm} of the processing time as an objective variable and using the pieces of resource information x₁ to x_{N} as explanatory variables, and newly obtains the following numerical expression 4.

t_{AJ}=k_{AJ1}′x₁+k_{AJ2}′x₂+ . . . +k_{AJN}′x_{N} numerical expression 4

In the numerical expression 4, k_{AJ1}′, k_{AJ2}′, . . . , and k_{AJN}′ are updated discrimination parameters respectively corresponding to the coprocessor 302-1, the coprocessor 302-2, . . . , and the coprocessor 302-N. By comparing the numerical expression 1 with the numerical expression 4, it can be found that the discrimination parameters corresponding to the coprocessor 302-1, the coprocessor 302-2, . . . , and the coprocessor 302-N are updated and the other parameters are not changed in the computational expression. The update unit 137 can hold the computational expression of the newly obtained numerical expression 4.

At a predetermined update timing, the update unit 137 accesses the discrimination parameter information 135, and replaces the computational expression corresponding to the combination of the coprocessor A and the processing J with the computational expression of the newly obtained numerical expression 4 by overwriting as illustrated in FIG. 5B. Due to this, the update unit 137 updates the discrimination parameter information 135. FIGS. 5A and 5B are diagrams illustrating update processing for the discrimination parameter information 135 (in a case of the coprocessor A and the processing J).

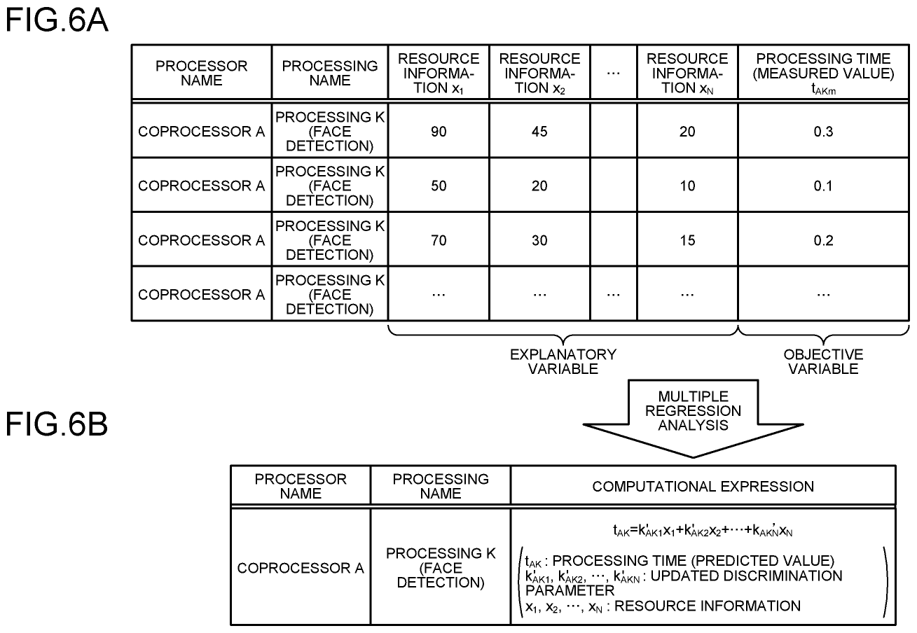

Alternatively, for example, it is assumed that the coprocessor A is selected to perform the processing K (face detection processing) based on the processing time (predicted value) obtained by the numerical expression 2. Through this processing, the measuring unit 136 measures a measurement value t_{AKm}=0.3 [s] of the processing time corresponding to the resource information x₁=90[%], x₂=45[%], . . . , x_{N}=20[%] illustrated in the first line of FIG. 6A. Assuming that the computational expression of the numerical expression 2 corresponding to the combination of the coprocessor A and the processing K is an expression obtained by performing multiple regression analysis on past data in the second line and the following lines of FIG. 6A, the computational expression may be changed by adding the newly obtained measurement result in the first line to perform multiple regression analysis. Thus, the measuring unit 136 supplies, to the update unit 137, a measurement result obtained by adding the data in the first line to the past data in the second line and the following lines of FIG. 6A. The update unit 137 performs multiple regression analysis using the measurement value t_{AJm} of the processing time as an objective variable and using the pieces of resource information x₁ to x_{N} as explanatory variables, and newly obtains the following numerical expression 5.

t_{AK}=k_{AK1}′x₁+k_{AK2}′x₂+ . . . +k_{AKN}′x_{N} numerical expression 5

In the numerical expression 5, k_{AK1}′, k_{AK2}′, . . . , and k_{AKN}′ are updated discrimination parameters respectively corresponding to the coprocessor 302-1, the coprocessor 302-2, . . . , and the coprocessor 302-N. By comparing the numerical expression 2 with the numerical expression 5, it can be found that the discrimination parameters corresponding to the coprocessor 302-1, the coprocessor 302-2, . . . , and the coprocessor 302-N are updated and the other parameters are not changed in the computational expression. The update unit 137 can hold the computational expression of the newly obtained numerical expression 5.

At a predetermined update timing, the update unit 137 accesses the discrimination parameter information 135, and replaces the computational expression corresponding to the combination of the coprocessor A and the processing K with the computational expression of the newly obtained numerical expression 5 by overwriting as illustrated in FIG. 6B. Due to this, the update unit 137 updates the discrimination parameter information 135. FIGS. 6A and 6B are diagrams illustrating update processing for the discrimination parameter information 135 (in a case of the coprocessor A and the processing K).

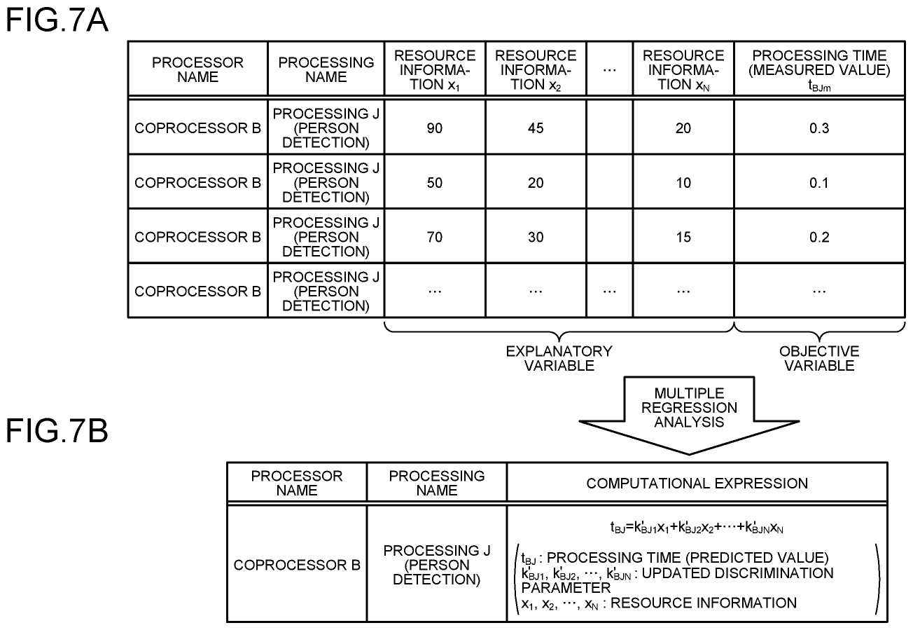

Alternatively, for example, it is assumed that the coprocessor B is selected to perform the processing J (person detection processing) based on the processing time (predicted value) obtained by the numerical expression 3. Through this processing, the measuring unit 136 measures a measurement value t_{BJm}=0.3 [s] of the processing time corresponding to the resource information x₁=90[%], x₂=45[%], x_{N}=20[%] illustrated in the first line of FIG. 7A. Assuming that the computational expression of the numerical expression 3 corresponding to the combination of the coprocessor B and the processing J is an expression obtained by performing multiple regression analysis on past data in the second line and the following lines of FIG. 7A, the computational expression may be changed by adding the newly obtained measurement result in the first line to perform multiple regression analysis. Thus, the measuring unit 136 supplies, to the update unit 137, a measurement result obtained by adding the data in the first line to the past data in the second line and the following lines of FIG. 7A. The update unit 137 performs multiple regression analysis using the measurement value t_{BJm} of the processing time as an objective variable and using the pieces of resource information x₁ to x_{N} as explanatory variables, and newly obtains the following numerical expression 6.

t_{BJ}=k_{BJ1}′x₁+k_{BJ2}′x₂+ . . . +k_{BJN}′x_{N} numerical expression 6

In the numerical expression 6, k_{BJ1}′, k_{BJ2}′, . . . , and k_{BJN}′ are updated discrimination parameters respectively corresponding to the coprocessor 302-1, the coprocessor 302-2, . . . , and the coprocessor 302-N. By comparing the numerical expression 3 with the numerical expression 6, it can be found that the discrimination parameters corresponding to the coprocessor 302-1, the coprocessor 302-2, . . . , and the coprocessor 302-N are updated and the other parameters are not changed in the computational expression. The update unit 137 can hold the computational expression of the newly obtained numerical expression 6.

At a predetermined update timing, the update unit 137 accesses the discrimination parameter information 135, and replaces the computational expression corresponding to the combination of the coprocessor B and the processing J with the computational expression of the newly obtained numerical expression 6 by overwriting as illustrated in FIG. 7B. Due to this, the update unit 137 updates the discrimination parameter information 135. FIGS. 7A and 7B are diagrams illustrating update processing for the discrimination parameter information 135 (in a case of the coprocessor B and the processing J).

Due to this, the parallel distributed control unit 131 can improve accuracy in parallel distributed control in accordance with a change in processing performance of the coprocessors 302-1 to 302-N.

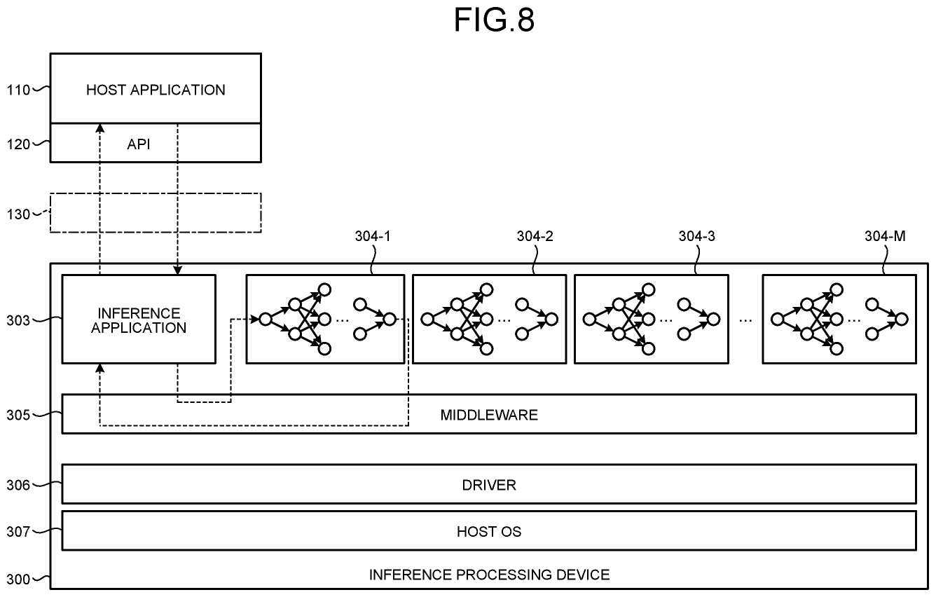

Next, the following describes an operation using the model file 304 of the inference processing device 300 with reference to FIG. 8. FIG. 8 is a diagram illustrating an operation using the model file 304 of the inference processing device 300.

In the inference processing device 300 illustrated in FIG. 8, the inference application 303 loads the middleware 305 and the model files 304-1 to 304-M to be used by the inference application 303 from among a plurality of pieces of middleware and a plurality of model files stored in the SSD 107 and/or the HDD 108 of the information processing device 100 using a virtual environment technique. The inference application 303 initializes the middleware 305 and the model files 304-1 to 304-M at the time of starting the inference processing device 300.

In a case in which the inference processing device 300 is selected as a transmission destination by the AI cluster management unit 130, the inference application 303 receives the inference request from the host application 110 via the API 120 and the AI cluster management unit 130. The inference request includes the inference processing identifier, the input data (an image, voice, a text, and the like) to be subjected to inference processing, and the parameter for setting an execution condition for inference processing. The inference request is converted into the common format by the API 120, and the inference application 303 receives the inference request in the common format. The inference application 303 specifies the model file 304 corresponding to the inference processing identifier included in the inference request, and converts the input data in the common format included in the inference request into a format of the specified model file 304.

In this case, the M model files 304-1 to 304-M may have formats different from each other. That is, the inference application 303 absorbs a difference in formats among the model files 304-1 to 304-M and enables transmission/reception of information in the common format to/from the host applications 110-1 to 110-n (that is, to/from the API 120).

For example, in a case in which the inference processing identifier corresponds to the model file 304-1, as illustrated in FIG. 8, the inference application 303 specifies the model file 304-1 as a model file to be executed based on the inference processing identifier included in the inference request, and notifies the middleware 305 of the specification result. The inference application 303 converts the input data in the common format into input data in a format of the model file 304-1 to be supplied to the middleware 305. The middleware 305 inputs the input data after format conversion to an input layer of the model file 304-1, and causes the model file 304-1 to perform inference processing. When output data (output data in a format of the model file 304-1) as an execution result of inference processing is supplied to the middleware 305 from the model file 304-1, the middleware 305 supplies the output data of the model file 304-1 to the inference application 303. The inference application 303 converts the output data in the format of the model file 304-1 into output data in the common format. The inference application 303 transmits the output data after format conversion to the host application 110 via the AI cluster management unit 130 and the API 120.

A format of the inference request received by the inference application 303 from the host application 110 is converted into the common format by the API 120, for example, a format as illustrated in FIG. 9A.

The common format illustrated in FIG. 9A is common in object determination for an image irrespective of a type of the model file. In the inference request, ai_name [character string] may be designated as the inference processing identifier. As parameters for setting the execution condition for inference processing, a width of an image: width [integral number], a height of an image: height [integral number], a color depth parameter: color_depth [integral number], a confidence threshold: confidence_threshold [floating-point number], a maximum number of returns: [integral number] may be designated. As data (an image) to be subjected to inference processing, image_data [byte array] (a byte array of “width×height×3×color_depth” (3=three layers of RGB)) may be designated.

In a case in which the model file 304-1 is a numeral recognition model, the numeral recognition model (model file 304-1) determines whether the image includes a numeral from 0 to 9. The input image is only a monochrome image of ‘28×28’, and the entire image is determined.

In this case, the inference application 303 converts the input data in the common format illustrated in FIG. 9A into input data that is monochromated and resized to be ‘28×28’ as input data in the format of the model file 304-1 illustrated in FIG. 9B.

The format of the model file 304-1 illustrated in FIG. 9B is a format of input data of a character recognition model (model file 304-1), and parameters for setting the execution condition for inference processing are not designated (a maximum number, a threshold, and the like are not designated). As data (image) to be subjected to inference processing, a 32-bit array of a float type (a floating-point number type) of ‘28×28×1’ may be designated.

For example, in a case in which a threshold of confidence as a parameter is assumed to be 0.5 and a color image of ‘100×100×3×8’ bits is received as the input data in the common format, the inference application 303 may convert the image into a monochrome image of ‘28×28×32’ bits to be input data of the model file 304-1.

FIGS. 9A and 9B are diagrams illustrating conversion processing from the common format into the format of the input layer of the model file 304-1.

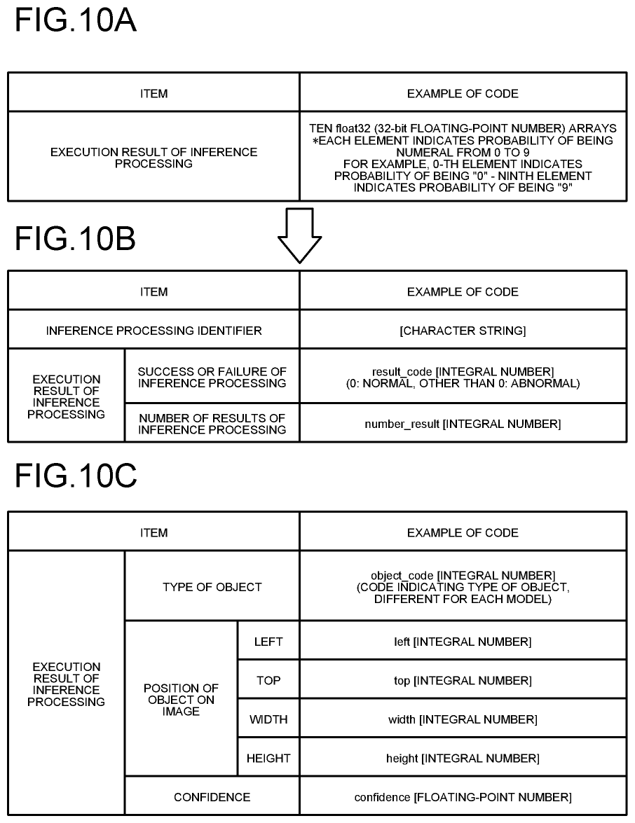

Output data as an execution result of inference processing by the model file 304-1 is output data in the format of the model file 304-1 as illustrated in FIG. 10A.

The format of the model file 304-1 illustrated in FIG. 10A is a format of output data of the character recognition model (model file 304-1), and ten 32-bit arrays of the float type (floating-point number type) (each element indicates a probability of being a numeral from 0 to 9. For example, the 0^{th} element indicates a probability of being “0”—the 9^{th} element indicates a probability of being “9”) may be designated as an execution result of inference processing.

In this case, the inference application 303 selects elements the number of which is equal to or larger than a threshold from among the ten arrays for the output data in the format of the model file 304-1 illustrated in FIG. 10A, returns an element number thereof as a type of an object and confidence as a probability of a numeral thereof, designates the entire image as a position, and obtains output data in the common format illustrated in FIGS. 10B and 10C.

The common format illustrated in FIG. 10B is a format of output data to the host application 110, which is common in object determination for an image irrespective of a type of the model file. In the output data in the common format, [character string] is designated as the inference processing identifier, and success or failure of inference processing: result_code [integral number] (0: normal, other than 0: abnormal) and the number of results of inference processing: number_result [integral number] are designated as execution results of inference processing. The number_result [integral number] (or the number of number_result) may designate object_class [integral number] (a code indicating a type of an object, which is different for each model) as a type of an object. As a position of the object on the image, the left: left [integral number], a top: top [integral number], a width: width [integral number], a height: height [integral number], and confidence: confidence [floating-point number] may be designated. FIGS. 10A to 10C are diagrams illustrating conversion processing from the format of the output layer of the model file 304-1 into the common format.

For example, when an array of

0.0, 0.0, 0.0, 0.3, 0.7, 0.0, 0.8, 0.6, 0.0, 0.0
is output as output data from the model file 304-1, the

inference application 303 converts the output data into

success or failure of inference processing: 0 #success

the number of results of inference processing: 3

#three of ten are numerical values equal to or larger than
0.5

{
[
the type of the object: 6 #the 6^{th} element (starting

from 0)

the position of the object on the image: 0, 0, 100,

100 #the entire image

confidence: 0.8
],
[
the type of the object: 4 #the 4^{th} element (starting

from 0)

the position of the object on the image: 0, 0, 100,

100 #the entire image

confidence: 0.7 #the 4^{th} numerical value is

confidence

],
[
the type of the object: 7 #the 7^{th} element (starting

from 0)

the position of the object on the image: 0, 0, 100,

100 #the entire image

confidence: 0.6 #the 7^{th} numerical value is

confidence

]
},

which may be caused to be output data in the common

format.

Alternatively, for example, in a case in which the inference processing identifier corresponds to the model file 304-2, as illustrated in FIG. 8, the inference application 303 specifies the model file 304-2 as a model file to be executed based on the inference processing identifier included in the inference request, and notifies the middleware 305 of the specification result. The inference application 303 also converts the input data in the common format into input data in a format of the model file 304-2 to be supplied to the middleware 305. The middleware 305 inputs the input data after format conversion to an input layer of the model file 304-2, and causes the model file 304-2 to perform inference processing. When output data (output data in the format of the model file 304-2) as an execution result of inference processing is supplied to the middleware 305 from the model file 304-2, the middleware 305 supplies the output data of the model file 304-2 to the inference application 303. The inference application 303 converts the output data in the format of the model file 304-2 into output data in the common format. The inference application 303 transmits the output data after format conversion to the host application 110 via the AI cluster management unit 130 and the API 120.

A format of the inference request received by the inference application 303 from the host application 110 is converted into the common format by the API 120, for example, a format as illustrated in FIG. 12A. The common format illustrated in FIG. 12A is the same as the common format illustrated in FIG. 9A.

In a case in which the model file 304-2 is an object recognition model, the object recognition model (model file 304-2) determines whether the image includes an object that can be identified (a person, a vehicle, a cat, and the like). The input image is an image having an optional size, the entire image is determined, and when an object is detected, the type (numeral), the position, and the confidence of the object are output.

In this case, the inference application 303 converts the input data (input image data) in the common format illustrated in FIG. 12A into input data obtained by adding one dimension (depth) thereto, which becomes input data in the format of the model file 304-2 illustrated in FIG. 12B.

The format of the model file 304-2 illustrated in FIG. 12B is a format of input data of the object recognition model (model file 304-2), and a maximum number, a type of an object to be determined, a threshold of confidence, data (image) to be subjected to inference processing: an array of unit 32 of ‘height×width×depth×3’ (the depth is for three-dimensional calculation and is not required normally) may be designated as parameters for setting the execution condition for inference processing.

For example, in a case in which the threshold of confidence is assumed to be 0.5 and the maximum number is assumed to be 5 as the parameters, and a color image of ‘100×100×3×8’ bits is received as input data in the common format, the inference application 303 may convert the image into an image of ‘100×100×1×3×32’ bits to be the input data of the model file 304-2, and may cause 0.5 as the threshold of confidence and 5 as the maximum number to be the parameters for narrowing the execution result of inference processing.

FIGS. 12A and 12B are diagrams illustrating conversion processing from the common format into the format of the input layer of the model file 304-2.

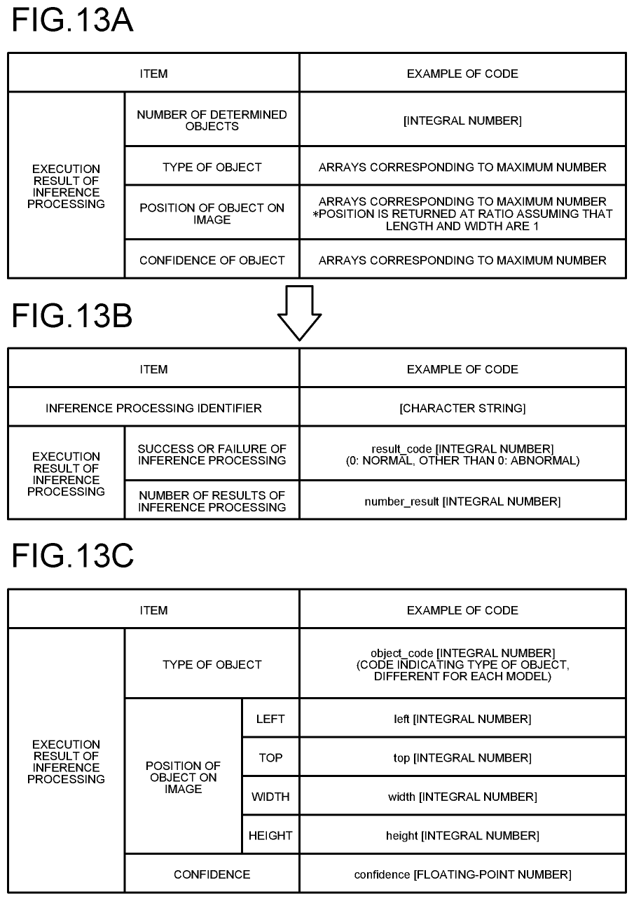

The output data as the execution result of inference processing performed by the model file 304-2 is output data in the format of the model file 304-2 illustrated in FIG. 13A.

The format of the model file 304-2 illustrated in FIG. 13A is a format of the output data of the object recognition model (model file 304-2), and the number of determined objects: [integral number], the type of the object: arrays corresponding to the maximum number, the position of the object: arrays corresponding to the maximum number (the position is returned at a ratio assuming that the length and the width are 1), confidence of the object: arrays corresponding to the maximum number may be designated as the execution result of inference processing.

In this case, the inference application 303 outputs only elements the confidence of which is equal to or larger than a threshold from among the arrays of the type, the position, the confidence, and the number of determined objects for the output data in the format of the model file 304-2 illustrated in FIG. 13A to be output data in the common format illustrated in FIGS. 13B and 13C.

The common format illustrated in FIGS. 13B and 13C is the same as the common format illustrated in FIGS. 10B and 10C.

For example, when

```
  the number of the determined objects 2
  the array of the type of the object [1, 4, 0, 0, 0]
```

(corresponding to the maximum number)

the array of the position of the object [[0.2, 0.15, 0.3,

0.2], [0.7, 0.8, 0.2, 0.1], 0, 0, 0] (corresponding to the
maximum number)

the array of the confidence of the object [0.8, 0.3, 0,

0, 0] (corresponding to the maximum number)

are output as the output data from the model file 304-1,

the inference application 303 may convert the output data
into

```
  success or failure of inference processing: 0 #success
  the number of results of inference processing: 1 #the
```

confidence of only one of five is equal to or larger than 0.5

{

[

the type of the object: 1 #the code indicating the type

of the object (defined for each model)

the position of the object on the image: 20, 15, 30, 20

#the position is converted into a coordinate value from a
ratio

the confidence: 0.8

]

```
  }
  to be the output data in the common format.
```

As described above, according to the embodiment, the information processing system 1 applies the resource information collected from the N coprocessors 302-1 to 302-N to the computational expression to calculate the processing time of each of the N coprocessors, and selects the coprocessor to which the inference processing is assigned and transmits the inference request thereto based on the processing times of the N coprocessors. For example, the information processing system 1 can select the coprocessor 302 having the shortest processing time and transmit the inference request thereto. Due to this, a vacancy status of current resource can be considered, so that efficiency of parallel distributed control can be improved in real time.

According to the embodiment, in the information processing device 100, the measuring unit 136 measures the processing time of the processor 302 that performs inference processing in response to the inference request. The update unit 137 performs multiple regression analysis based on the received resource information of the N coprocessors 302-1 to 302-N and the measured processing time, and updates the computational expression. Due to this, the information processing device 100 can cope with a change in processing performance of the N coprocessors 302-1 to 302-N, and accuracy in parallel distributed control can be improved.

According to the embodiment, in the information processing device 100, the computational expressions include the N discrimination parameters corresponding to the N coprocessors 302-1 to 302-N, and the update unit 137 updates the N discrimination parameters in the computational expressions. Due to this, the computational expression can be updated in accordance with a change in processing performance of the N coprocessors 302-1 to 302-N.

According to the embodiment, in the information processing device 100, the inference request includes the inference processing identifier for identifying content of the inference processing. The calculation unit 1312a applies the resource information of the N coprocessors 302-1 to 302-N to the N computational expressions corresponding to inference processing content that is identified with the inference processing identifier among ‘N×M’ computational expressions associated with the combinations of the N different coprocessors 302-1 to 302-N and the M different pieces of inference processing content. Due to this, in a case in which the parallel distribution system includes a coprocessor that performs specific processing at high speed, the processing content can also be considered to be a difference in performance in addition to the arithmetic processing capacity, so that accuracy in parallel distributed control can be improved.

The information processing device 100 according to the embodiment generates the inference request including the inference processing identifier for identifying the content of inference processing, and transmits the inference request to the inference processing device 300. Due to this, the inference processing device 300 can specify the model file with the inference processing identifier, prevent an unnecessary model file from being loaded, and load only a model file required for inference processing into a memory to perform inference processing. Thus, it is sufficient that the inference processing device 300 includes hardware including a memory and the like having performance for loading one model file to perform inference processing. As a result, the information processing system 1 can efficiently perform inference processing and respond to a request from the host application even with the inference processing device 300 having low hardware performance.

According to the embodiment, in the information processing device 100, the N coprocessors 302-1 to 302-N as control objects of parallel distributed control perform inference processing in response to the inference request. Due to this, processing of repeatedly performing the same processing is performed by the coprocessor 302, so that an approximate processing time can be easily estimated from resource statuses of the coprocessors 302-1 to 302-N.

According to the embodiment, in the inference processing device 300, the M model files 304-1 to 304-M respectively correspond to different pieces of inference processing. The middleware 305 can execute each of the M model files 304-1 to 304-M. The inference application 303 receives the inference request including the inference processing identifier and the input data from the information processing device 100, and specifies the model file corresponding to the inference processing identifier among the M model files 304-1 to 304-M. The middleware 305 reads the specified model file, and performs inference processing. Due to this, as compared with a case in which the same pre-learned model is used for various kinds of inference processing, the model file 304 the efficiency of which is improved by machine learning can be used for each piece of inference processing, so that efficiency of inference processing performed by the inference processing device 300 can be improved.

According to the embodiment, in the inference processing device 300, the inference application 303 receives the inference request including the inference processing identifier and the input data in the common format from the information processing device 100. The inference application 303 converts the input data in the common format into input data in a format that can be executed by the model file 304 corresponding to the inference processing identifier among the M model files 304-1 to 304-M. The middleware 305 executes the specified model file 304 using the input data in that format. Due to this, inference processing can be performed by the model file 304 using the input data received from the information processing device 100.

According to the embodiment, in the inference processing device 300, the inference application 303 converts the output data in the format for the model file 304 obtained by executing the specified model file 304 into the output data in the common format to be transmitted to the information processing device 100. Due to this, the execution result of inference processing of the model file 304 can be provided to the information processing device 100.

According to the embodiment, the inference processing device 300 receives the inference request including the inference processing identifier corresponding to the other model file 304 and the input data in the common format from the information processing device 100. The inference application 303 converts the input data in the common format into input data in a format that can be executed by the other model file 304 corresponding to the inference processing identifier among the M model files 304-1 to 304-M. The middleware 305 executes the other specified model file 304 using the input data in that format. Due to this, inference processing can be performed by the other model file 304 using the input data received from the information processing device 100.

According to the embodiment, in the inference processing device 300, the inference application 303 converts the output data in the format for the other model file 304 obtained by executing the other specified model file 304 into the output data in the common format to be transmitted to the information processing device 100. Due to this, the execution result of inference processing of the other model file 304 can be provided to the information processing device 100.

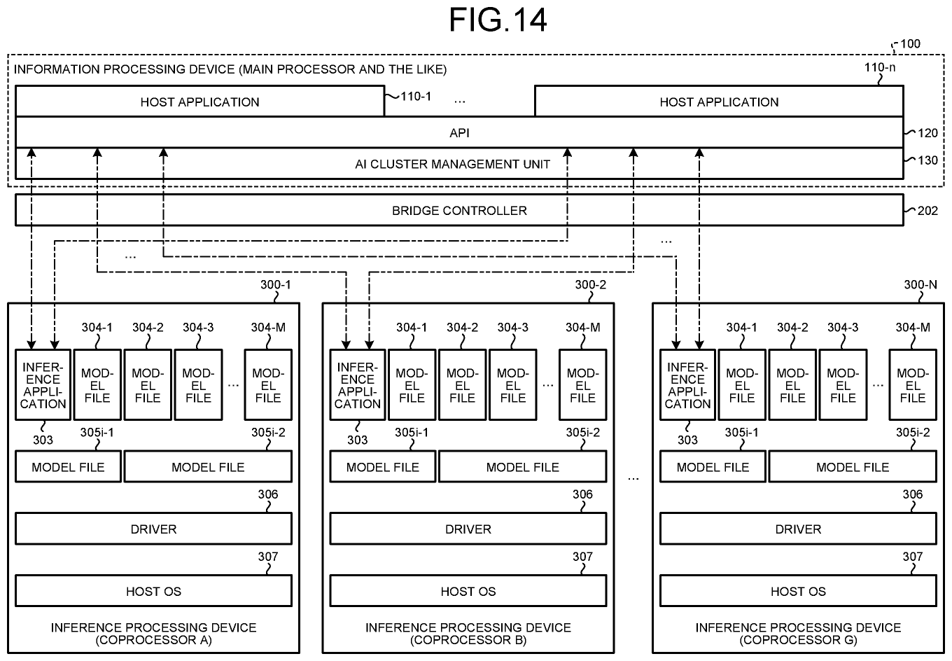

It should be noted that, as illustrated in FIG. 14, each of the inference processing devices 300-1 to 300-N may include a plurality of pieces of middleware 305i-1 and 305i-2. FIG. 14 is a diagram illustrating a functional configuration of the inference processing device 300 according to a modification of the embodiment.

In this case, each of the pieces of middleware 305i-1 and 305i-2 corresponds to one or more model files among the M model files 304-1 to 304-M. For example, in a case of FIG. 14, the middleware 305i-1 corresponds to one model file 304-1, and the middleware 305i-2 corresponds to (M−1) model files 304-2 to 304-M.

The inference application 303 specifies a group corresponding to the inference processing identifier among a plurality of groups each including the middleware 305i and the model file 304 corresponding to the middleware. The middleware 305i included in the specified group executes the model file 304 included in the specified group.

For example, in a case of FIG. 14, there are (middleware 305i-1, model file 304-1), (middleware 305i-2, model file 304-2), (middleware 305i-2, model file 304-3), . . . , and (middleware 305i-2, model file 304-M) as M groups.

In a case in which the inference processing identifier corresponds to the model file 304-1, the inference application 303 specifies (middleware 305i-1, model file 304-1) to be a group corresponding to the inference processing identifier. In this case, the middleware 305i-1 executes the model file 304-1.

In a case in which the inference processing identifier corresponds to the model file 304-2, the inference application 303 specifies (middleware 305i-2, model file 304-2) to be a group corresponding to the inference processing identifier. In this case, the middleware 305i-2 executes the model file 304-2.

In this way, also in a case in which each of the inference processing devices 300-1 to 300-N includes the pieces of middleware 305i-1 and 305i-2, the model file 304 the efficiency of which is improved by machine learning can be used for each piece of inference processing, so that efficiency in inference processing performed by the inference processing device 300 can be improved.

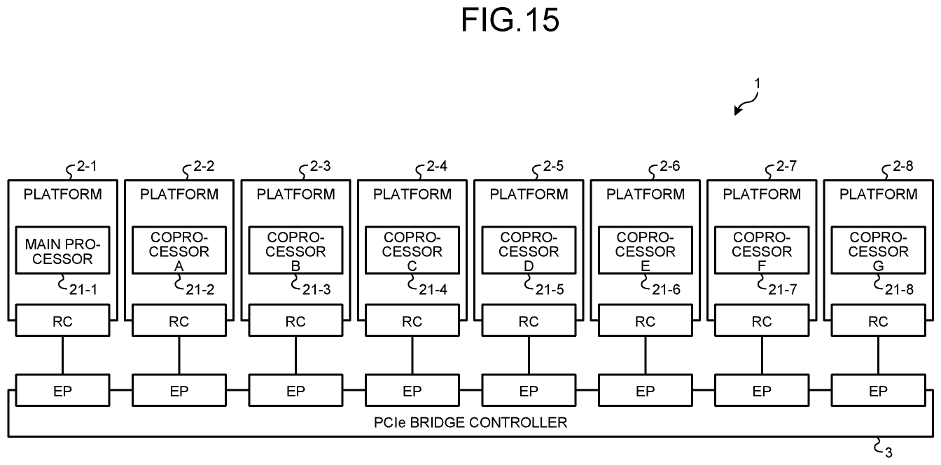

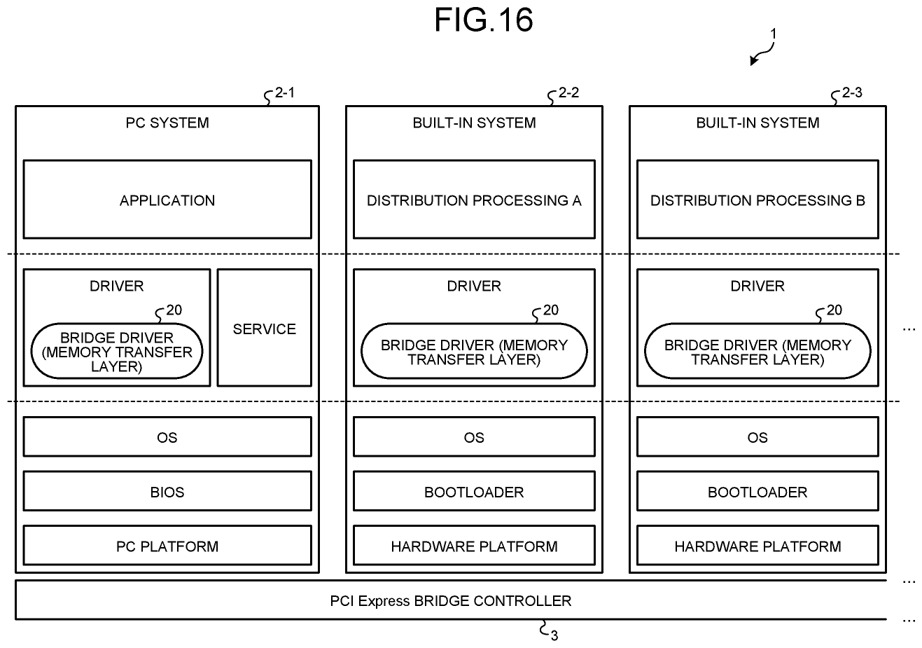

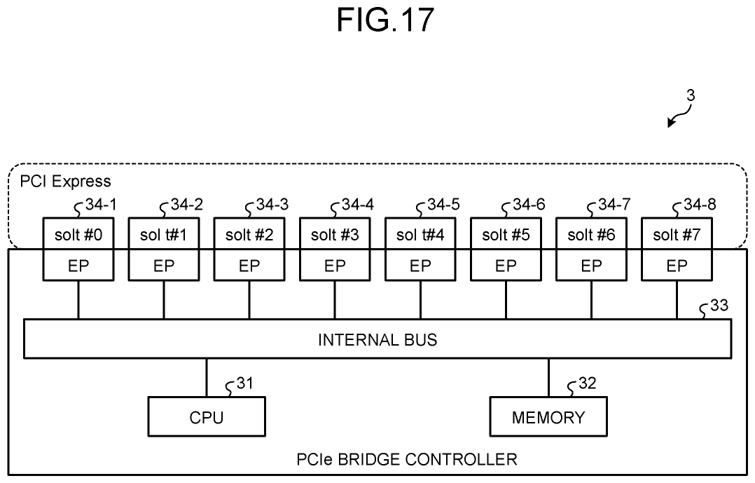

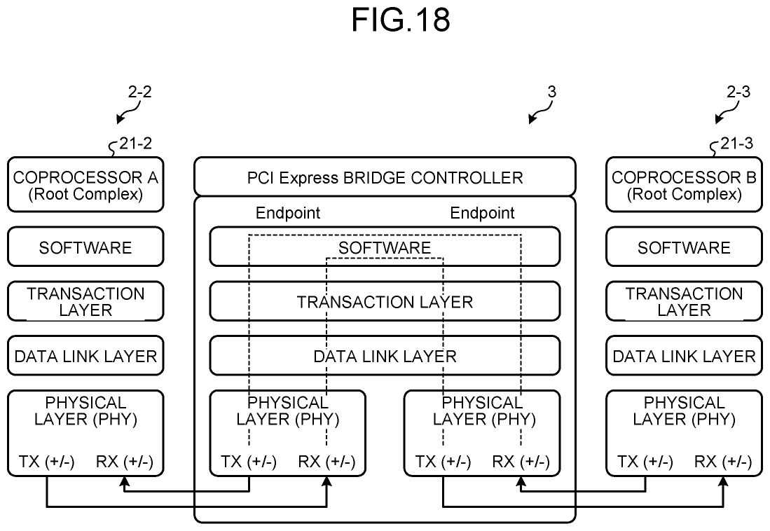

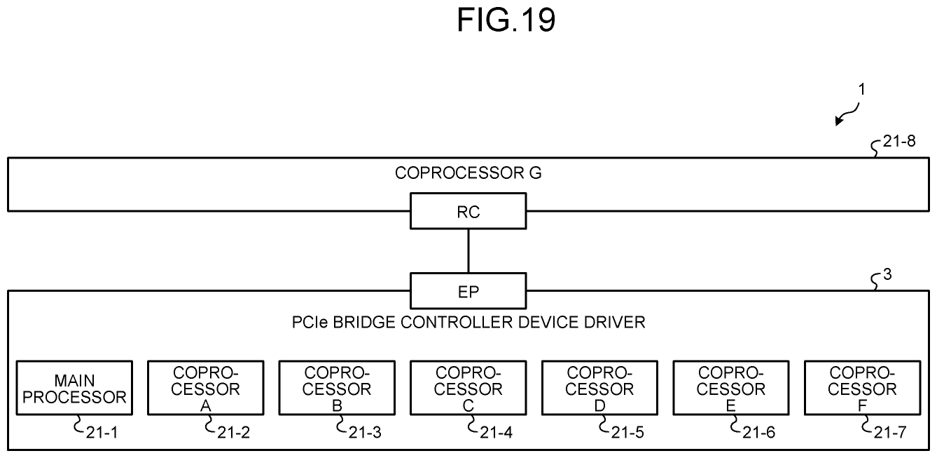

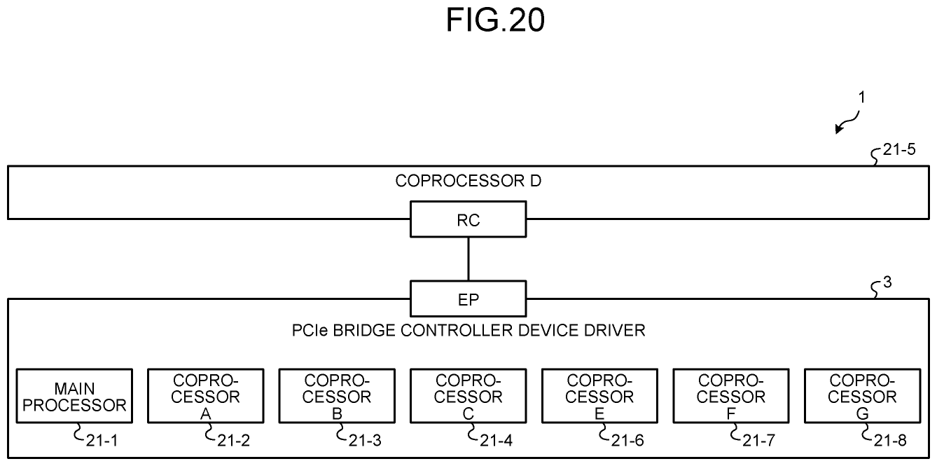

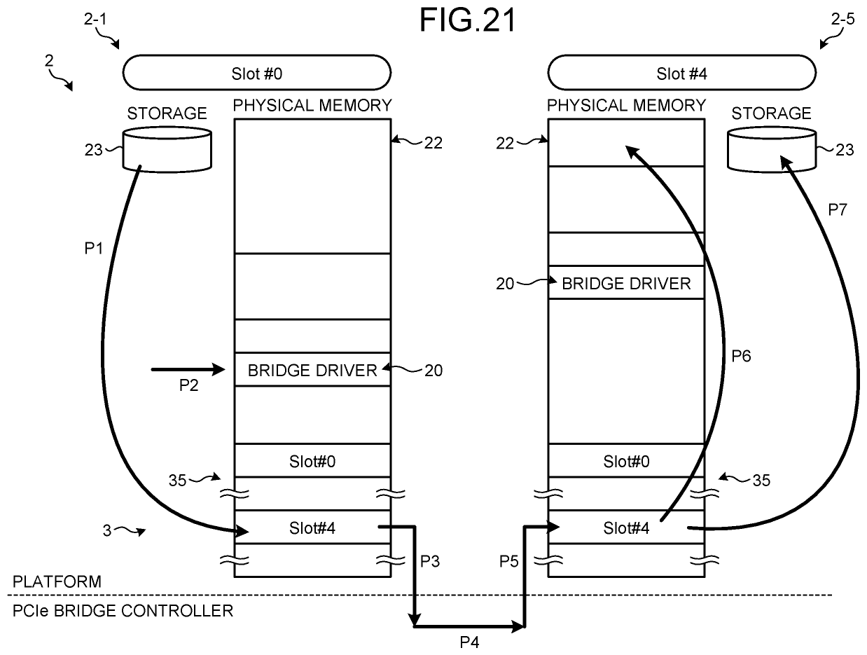

Alternatively, the bridge controller 202 may be a PCIe bridge controller 3 conforming to a Peripheral Component Interconnect express (PCIe) standard as illustrated in FIGS. 15 to 21. FIG. 15 is a diagram illustrating a hardware configuration of the information processing system according to another modification of the embodiment. FIG. 16 is a diagram illustrating a software configuration of the information processing system according to another modification of the embodiment. FIG. 17 is a diagram illustrating a hardware configuration of the PCIe bridge controller according to another modification of the embodiment. FIG. 18 is a diagram illustrating a layer configuration of the PCIe according to another modification of the embodiment. FIG. 19 is a diagram illustrating appearance of the other processors viewed from the coprocessor G according to another modification of the embodiment. FIG. 20 is a diagram illustrating appearance of the other processors viewed from the coprocessor D according to another modification of the embodiment. FIG. 21 is a diagram illustrating data transfer processing between processors via the PCIe bridge controller according to another modification of the embodiment.

The information processing system 1 exemplified in FIG. 15 includes the PCIe bridge controller 3 and a plurality of (eight in the example illustrated in FIG. 4) platforms 2-1 to 2-8. Each of the platforms 2-1 to 2-8 is connected to the PCIe bridge controller 3.

Hereinafter, as a reference numeral indicating the platform, the reference numerals 2-1 to 2-8 are used in a case in which one of the platforms needs to be specified, but the reference numeral 2 is used for indicating an optional platform. The platform 2 may also be called a PC platform 2.

The platform 2-1 includes a main processor 21-1. The main processor 21-1 corresponds to the main processor 102 according to the embodiment. The platforms 2-2 to 2-8 respectively include coprocessors 21-2 to 21-8. The coprocessors 21-2 to 21-8 respectively correspond to the coprocessors 302-1 to 302-N according to the embodiment.

The main processor 21-1 and the coprocessors 21-2 to 21-8 may be provided by different manufacturers (vendors). For example, it is assumed that the main processor 21-1, the coprocessor 21-2, the coprocessor 21-3, the coprocessor 21-4, the coprocessor 21-5, the coprocessor 21-6, the coprocessor 21-7, and the coprocessor 21-8 are provided by a company A, a company B, a company C, a company D, a company E, a company F, a company G, and a company H, respectively.

In the following description, the coprocessor 21-2, the coprocessor 21-3, the coprocessor 21-4, the coprocessor 21-5, the coprocessor 21-6, the coprocessor 21-7, and the coprocessor 21-8 are respectively called coprocessors A, B, C, D, E, F, and G in some cases. Different platforms may be respectively connected to EPs mounted on the PCIe bridge controller. Additionally, two or more EPs may be connected to one platform, and the platform may use a plurality of RCs to communicate with the PCIe bridge controller.

In the following description, the reference numerals 21-1 to 21-8, reference signs A to G, or the like are used as the reference numeral indicating the processor in a case in which one of the processors needs to be specified, but the reference numeral 21 is used for indicating an optional processor.

The platforms 2-1 to 2-8 are computer environments for performing arithmetic processing such as AI inference processing and image processing, and include the processor 21, and the storage 23 and a memory (physical memory) 22 illustrated in FIG. 21.

In the platform 2, the processor 21 executes a computer program stored in the memory 22 or the storage 23 to implement various functions.

The storage 23 is a storage device such as a hard disk drive (HDD), a solid state drive (SSD), and a storage class memory (SCM), which stores various kinds of data.

The memory 22 is a storage memory including a read only memory (ROM) and a random access memory (RAM). Various software programs and data and the like for the software programs are written in the ROM of the memory 22. The software program on the memory 22 is read by the processor 21 to be executed as needed. The RAM of the memory 22 is used as a primary storage memory or a working memory.

The processor 21 (the main processor 21-1 or the coprocessors 21-2 to 21-8) controls the entire platform 2. The processor 21 may be a multiprocessor. The processor 21 may be, for example, any one of a central processing unit (CPU), a graphics processing unit (GPU), a micro processing unit (MPU), a digital signal processor (DSP), an application specific integrated circuit (ASIC), a programmable logic device (PLD), and a field programmable gate array (FPGA). The processor 21 may be a combination of two or more types of elements among the CPU, the GPU, the MPU, the DSP, the ASIC, the PLD, and the FPGA. For example, each of the coprocessors 21-2 to 21-8 may be a combination of the CPU and the GPU.

In the information processing system 1 exemplified in FIG. 16, the platform 2-1 uses Windows as an OS, and a shop management program is executed on the OS. The shop management program corresponds to the host application 110 according to the embodiment. Each of the platforms 2-2 and 2-3 uses Linux (registered trademark) as an OS, and a distribution processing program (pieces of distribution processing A and B) is executed on the OS. The distribution processing program (pieces of distribution processing A and B) corresponds to the inference application 303 according to the embodiment.

Each platform 2 includes a bridge driver 20, and the platform 2 communicates with the PCIe bridge controller 3 and the other platform 2 via the bridge driver 20. A communication method performed by the bridge driver 20 will be described later.

Each platform 2 includes the processor 21 and the memory (physical memory) 22, and the processor 21 executes an OS, various computer programs, a driver, and the like stored in the memory 22 to implement functions thereof.

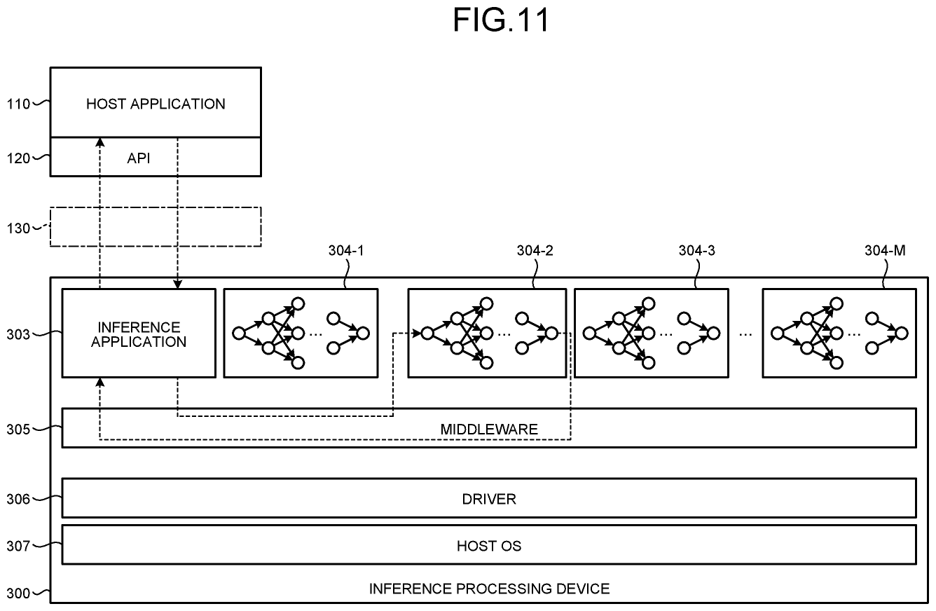

The processors 21 (the main processor 21-1 or the coprocessors 21-2 to 21-8) included in the respective platforms 2 may be provided by different vendors. In the example illustrated in FIG. 11, a platform including a plurality of RCs (for example, an x86 processor manufactured by Intel Corporation) may be used as at least some of the platforms 2 (for example, the platform 2-1).

Each platform 2 is configured to be able to operate independently without influencing other driver configurations.

In the platform 2, as described later with reference to FIG. 21, part of a storage region of the memory 22 is used as a communication buffer 221 that temporarily stores data transferred between the platforms 2 (between the processors 21).

The PCIe bridge controller 3 implements communication of data and the like among the platforms 2-1 to 2-8.

The PCIe bridge controller 3 illustrated in FIG. 17 is, for example, a relay device including an 8-channel EP in one chip. The PCIe bridge controller 3 includes, as illustrated in FIG. 17, a CPU 31, a memory 32, an interconnect 33, and a plurality of (eight in the example illustrated in FIG. 17) slots 34-1 to 34-8.

A device configured to conform to the PCIe standard is connected to each of the slots 34-1 to 34-8. For example, in the information processing system 1, the platform 2 is connected to each of the slots 34-1 to 34-8.

In the following description, as a reference numeral indicating the slot, the reference numerals 34-1 to 34-8 are used in a case in which one of the slots needs to be specified, but the reference numeral 34 is used for indicating an optional slot.

One processor 2 may be connected to one slot 34 like the platforms 2-2 to 2-8 in FIG. 15. Alternatively, one platform 2 may be connected to a plurality of (two in the example of FIG. 4) slots 34 like the platform 2-1 in FIG. 15. The embodiment can be variously modified to be implemented.

Like the platform 2-1 in FIG. 15, by assigning a plurality of slots 34 to one platform 2, the platform 2-7 can be caused to perform communication using a wide communication band.

Each slot 34 is connected to the interconnect 33 via an internal bus. The CPU 31 and the memory 32 are connected to the interconnect 33. Due to this, each slot 34 is connected to the CPU 31 and the memory 32 to be able to communicate with each other via the interconnect 33.

The memory 32 is, for example, a storage memory (physical memory) including a ROM and a RAM. A software program related to data communication control, and data and the like for the software program are written in the ROM of the memory 32. The software program on the memory 32 is read by the CPU 31 to be executed as needed. The RAM of the memory 32 is used as a primary storage memory or a working memory.

Each platform 2 includes a memory region 35 (refer to FIG. 21) corresponding to each slot, a plurality of storage regions that are divided corresponding to the number of slots are set to the memory region 35, and each of the storage regions is associated with any of the slots 305. That is, in the memory region 35 of the memory 22, storage regions respectively corresponding to slots #0 to #7 are disposed.

As described later, the PCIe bridge controller 3 performs data transfer between the platforms 2 using the storage region of the memory region 35 associated with each slot.

The CPU 31 controls the entire PCIe bridge controller 3. The CPU 31 may be a multiprocessor. Any one of an MPU, a DSP, an ASIC, a PLD, and an FPGA may be used in place of the CPU 31. The CPU 31 may be a combination of two or more types of elements among a CPU, an MPU, a DSP, an ASIC, a PLD, and an FPGA.

When the CPU 31 executes the software program stored in the memory 32, data transfer between the platforms 2 (between the processors 21) by the PCIe bridge controller 3 is implemented.

The PCIe bridge controller 3 uses the PCIe for increasing the speed of data transfer between the platforms 2, causes the processors included in the respective platforms 2 to operate as RCs as illustrated in FIG. 15, and implements data transfer between EPs operating as devices.

Specifically, in the information processing system 1, the processors of the respective platform 2 are caused to operate as RCs of the PCIe as data transfer interfaces. For each of the platforms 2 (processors 21), the PCIe bridge controller 3, that is, the slot 34 to which each platform 2 is connected is caused to operate as the EP.

A method of connecting the PCIe bridge controller 3 to the processor 21 as the EP may be implemented by using various known methods.

For example, the PCIe bridge controller 3 notifies the processor 21 of a signal indicating to function as the EP at the time of being connected to the platform 2, and is connected to the processor 21 as the EP.

The PCIe bridge controller 3 tunnels the data by End Point to End Point (EPtoEP), and transfers the data to the RCs. Communication between the processors is logically connected at the time when a transaction of the PCIe is generated. When data transfer is not concentrated on one processor, data transfer can be performed between the respective processors in parallel.

FIG. 18 illustrates an example in which the coprocessor A of the platform 2-2 communicates with the coprocessor B of the platform 2-3.

In the platform 2-2 as a transmission source, the data generated by the coprocessor A as the RC is successively transferred through software, a transaction layer, a data link layer, and a physical layer (PHY), and is transferred from the physical layer to a physical layer of the PCIe bridge controller 3.

In the PCIe bridge controller 3, the data is successively transferred through the physical layer, the data link layer, the transaction layer, and the software, and is transferred to the EP corresponding to the RC of the platform 2 as a transmission destination by tunneling.

That is, in the PCIe bridge controller 3, by tunneling the data between the EPs, the data is transferred from one of the RCs (coprocessor 21-2) to the other RC (coprocessor 21-3).

In the platform 2-3 as a transmission destination, the data transferred from the PCIe bridge controller 3 is successively transferred through the physical layer (PHY), the data link layer, the transaction layer, and the software, and is transferred to the coprocessor B of the platform 2-3 as a transmission destination.

In the information processing system 1, communication between the processors 21 (between the platforms 2) is logically connected at the time when a transaction of the PCIe is generated.

When data transfer from the other processors 21 is not concentrated on a specific processor 21 connected to one of the eight slots included in the PCIe bridge controller 3, data transfer may be performed between the respective processors 21 in a plurality of different optional groups in parallel.

For example, in a case in which each of the coprocessor A of the platform 2-2 and the coprocessor B of the platform 2-3 tries to communicate with the main processor of the platform 2-1, the PCIe bridge controller 3 processes communication of the coprocessor A and the coprocessor B in serial.

However, in a case in which different processors communicate with each other and communication is not concentrated on a specific processor like the main processor—coprocessor A, the coprocessor B—the coprocessor C, and the coprocessor D—the coprocessor E, the PCIe bridge controller 3 processes communication between the processors 21 in parallel.

FIG. 19 is a diagram exemplifying appearance of the other processors 21 viewed from the processor 21-8 (processor G) in the information processing system 1 as an example of the embodiment, and FIG. 20 is a diagram exemplifying appearance of the other processors 21 viewed from the processor 21-5 (processor D).

In a state in which the processors 21 communicate with each other, only the PCIe bridge controller 3 can be viewed from the OS (for example, a device manager of Windows) on each of the processors 21, and it is not required to directly manage the other processors 21 as connection destinations. That is, it is sufficient that a device driver of the PCIe bridge controller 3 manages the processors 21 connected to the PCIe bridge controller 3.

Thus, it is not required to prepare a device driver for operating the respective processors 21 of the transmission source and the reception destination, and communication between the processors 21 can be performed by only performing communication processing on the PCIe bridge controller 3 with the driver of the PCIe bridge controller 3.

The following describes a method of performing data transfer between the processors 21 via the PCIe bridge controller 3 in the information processing system 1 as an example of the embodiment configured as described above with reference to FIG. 21.

In the example illustrated in FIG. 21, described is a case in which the data is transferred from the platform 2-1 connected to the slot #0 to the platform 2-5 connected to the slot #4.

The platform 2-1 as a data transmission source stores data (hereinafter, referred to as transmission data in some cases) transmitted by software and the like in the memory region 35 of the platform 2-1 from the storage 23 and the like included in the platform 2-1 (refer to the reference numeral P1). The memory region 35 may be part of the communication buffer 221. Memory regions 35 are regions having the same size disposed in the memory 22 and the like of the respective platforms 2. The memory region 35 is divided in accordance with the number of slots. The divided storage region of the memory region 35 is associated with any of the slots. For example, the storage region represented as the slot #0 in the memory region 35 is associated with the platform 2-1 connected to the slot #0, and the storage region represented as the slot #4 in the memory region 35 is associated with the platform 2-5 connected to the slot #0.

The platform 2-1 stores the transmission data in a region (in this case, the slot #4) assigned to the slot as a transmission destination in the memory region 35.

The bridge driver 20 acquires or generates slot information indicating the slot as a transmission destination and address information indicating an address of the transmission destination in the divided region in the memory region 35 based on the storage region of the memory region 35 in the platform 2 (refer to reference numeral P2).

In the transmission source EP, the bridge driver 20 passes transfer data including the slot information, the address information, and the transmission data to the PCIe bridge controller (relay device) 3 (refer to reference numeral P3). Due to this, the PCIe bridge controller 3 connects the slot as a transmission source to the slot as a transmission destination by EPtoEP based on the slot information to transfer the transfer data to the platform 2-4 as a transmission destination (refer to the reference numeral P4). The bridge driver 20 as a transmission destination stores the transmission data (or the transfer data) in a region at an address indicated by the address information in the storage region corresponding to the slot #4 of the memory region 35 in the platform 2 as a transmission destination based on the slot information and the address information (refer to the reference numeral P5).

In the transmission destination platform 2, for example, a computer program reads out the transmission data stored in the memory region 35 to be moved to the memory (local memory) 22 or the storage 23 (refer to the reference numerals P6 and P7).

In the way described above, the data (transfer data) is transferred from the platform 2-1 as a transfer source to the platform 2-5 as a transfer destination.

In this way, in the information processing system 1, the PCIe bridge controller 3 mediates data transfer between the EPs in the PCIe bridge controller 3. This configuration implements data transfer between the RCs (processors 21) connected to the PCIe bridge controller 3.

That is, each processor 21 is caused to independently operate as the RC of the PCIe, the device to be connected to each processor 21 is connected thereto as the EP in the PCIe bridge controller 3, and data transfer is performed between the EPs. Due to this, a problem caused by the device driver can be avoided, and high-speed data transfer can be operated as one system.

Data transfer between different processors 21 is enabled only with a data communication function adapted to the PCIe standard, so that choices of the processor 21 to be used can be increased without concerning for presence of the device driver, a supported OS, and the like.

The respective processors 21 are connected via the PCIe bridge controller 3 as the EP, so that a device driver for the RC ahead of the EP is not required to be added. Thus, the device driver is not required to be developed, and a failure caused by adding the device driver can be prevented.

In the information processing system 1, a typical processor such as an ARM processor and an FPGA is required to operate as the RC, so that the processor can be easily added as the processor 21 of the information processing system 1.

The PCIe bridge controller 3 implements connection (communication) by the PCIe, so that it is possible to implement high-speed transfer that cannot be implemented by Ethernet. Transmission/reception of a high-definition image such as a 4K or 8K image between the processors, parallel computation of large-scale big data, and the like can be implemented.

A dedicated processor dedicated to each function such as image processing or data retrieval can also be connected, so that a function can be added and performance can be improved at low cost.

In the information processing system 1, the system is not required to be virtualized, and system performance is prevented from being lowered due to virtualization of the system. Thus, the information processing system 1 can also be applied to a system used for a high-load arithmetic operation such as AI inference or image processing.

The technique disclosed herein is not limited to the embodiment described above, and can be variously modified to be implemented without departing from the gist of the embodiment. The configurations and the pieces of processing according to the embodiment can be picked and chosen as needed, or may be appropriately combined with each other.

For example, in the configuration illustrated in FIG. 17, the PCIe bridge controller 3 includes eight slots 34-1 to 34-8, but the configuration is not limited thereto. The configuration may be variously modified to be implemented. That is, the PCIe bridge controller 3 may include seven or less, or nine or more slots 34.

In the embodiment described above, the PCIe is exemplified as an I/O interface for each unit, but the I/O interface is not limited to the PCIe. For example, the I/O interface for each unit may be a technique of performing data transfer between a device (peripheral control controller) and a processor via a data transfer bus. The data transfer bus may be a general-purpose bus that can transfer data at high speed in a local environment (for example, one system or one device) disposed in one housing and the like. The I/O interface may be any of a parallel interface and a serial interface.

The I/O interface may have a configuration that can implement point-to-point connection, and can serially transfer data on a packet basis. The I/O interface may have a plurality of lanes in a case of serial transfer. A layer structure of the I/O interface may include a transaction layer that generates and decodes a packet, a data link layer that performs error detection and the like, and a physical layer that converts serial to parallel or parallel to serial. The I/O interface may also include a root complex that is the top of a hierarchy and includes one or a plurality of ports, an end point serving as an I/O device, a switch for increasing the ports, a bridge that converts a protocol, and the like. The I/O interface may multiplex a clock signal and data to be transmitted using a multiplexer, and transmit the data and the clock signal. In this case, a reception side may separate the data from the clock signal using a demultiplexer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a main processor, the main processor:
receives resource information related to a processing status from each of N processors assuming that N is an integral number equal to or larger than 2;
applies the received resource information of the N processors to a computational expression and calculates processing times corresponding to a processing request from an application for the respective N processors;
selects one processor from among the N processors based on the processing times of the N processors; and
transmits the processing request to the one processor.

2. The information processing device according to claim 1, wherein
the main processor is further:
measures a processing time of the one processor corresponding to the processing request; and
performs multiple regression analysis based on the received resource information of the N processors and the measured processing time of the one processor, and updates the computational expression.

3. The information processing device according to claim 2, wherein
the computational expression includes N parameters corresponding to the N processors, and
the main processor updates the N parameters in the computational expression.

4. The information processing device according to claim 1, wherein
the processing request includes a processing identifier for identifying processing content, and
the main processor applies the resource information of the N processors to N computational expressions corresponding to processing content identified with the processing identifier among a ‘N×M’ computational expressions associated with combinations of N different processors and M different pieces of processing content.

5. The information processing device according to claim 1, wherein
each of the N processors is an inference processing device configured to perform inference processing corresponding to the processing request.

6. An information processing system comprising:
the information processing device according to claim 1; and
N processors each of which is connected to the information processing device, wherein assuming that N is an integral number equal to or larger than 2.

7. An inference processing device comprising:
a processor, wherein the processor:
causes middleware to execute a plurality of model files corresponding to different pieces of inference processing; and
causes an inference application to receive a first inference request including a first inference processing identifier and first input data from outside, and to specify a model file corresponding to the first inference processing identifier among the model files, wherein
the processor further causes the middleware to read the specified model file and to perform the inference processing.

8. The inference processing device according to claim 7, wherein
the inference processing device stores a plurality of pieces of the middleware,
each of the pieces of the middleware corresponds to one or more model files among the model files,
the processor causes the inference application to specify a group corresponding to the first inference processing identifier among a plurality of groups each including middleware and the model files corresponding to the middleware, and
the processor causes the middleware included in the specified group to read the model files included in the specified group, and to execute the inference processing.

9. The inference processing device according to claim 7, wherein
the processor causes the inference application to receive the first inference request including the first inference processing identifier and first input data in a common format from the outside, and to convert the first input data in the common format into the first input data in a first format that is able to be executed by the model file corresponding to the first inference processing identifier among the model files, and
the processor causes the middleware to read the specified model file and to execute the inference processing using the first input data in the first format.

10. The inference processing device according to claim 9, wherein
the processor causes the inference application to convert first output data in the first format obtained by executing the specified model file into the first output data in the common format and to transmit the converted first output data to the outside.

11. The inference processing device according to claim 9, wherein
the processor causes the inference application to receive a second inference request including a second inference processing identifier and second input data in the common format from the outside, and to convert the second input data in the common format into the second input data in a second format that is able to be executed by the model file corresponding to the second inference processing identifier among the model files, and
the processor causes the middleware to read the specified model file and to perform the inference processing using the second input data in the second format.

12. The inference processing device according to claim 11, wherein
the processor causes the inference application to convert the first output data in the first format obtained by executing the specified model file into the first output data in the common format and to transmit the converted first output data to the outside, and to convert a second output data in the second format obtained by executing the specified model file into the second output data in the common format and to transmit the converted second output data to the outside.

13. An information processing system comprising:
an information processing device; and
the inference processing device according to claim 7 that is connected to the information processing device.
